(19) United States
(12) Patent Application Publication
(10) Pub. No.: US 2002/0133904 A1
(43) Pub. Date: Sep. 26, 2002

(54) Door closer

(75) Inventors: Neil J. Donovan, Erie, PA (US); Charles B. Atz, Edinboro, PA (US); Keith R. Ptak, Erie, PA (US); Peter A. Masterson, Erie, PA (US); Scott K. Miller, Raleigh, NC (US); Peter D. Howorth, Fairview, PA (US); Atle Larsen, Erie, PA (US)

Correspondence Address: Michael M. Gnibus, Lord Corporation, 111 Lord Drive, Post Office Box 8012, Cary, NC, 27512-8012, US

(73) Assignee: Lord Corporation

(21) Appl. No.: 09/816,990

(22) Filed: Mar. 23, 2001

(51) Int. Cl. E05F 3/00

(52) U.S. Cl. 16/49

(57) ABSTRACT

A door closer, for controlling the movement of a door as the door is opened and closed, the door closer comprising: an input member movable in response to movement of the door, the input member being movable in a first direction and in a second direction; return means for moving the input member in the second direction; and damping means for controlling the movement of the input member in the second direction, the damping means comprising: a rubbing member movable in the first and second directions, and a body for engagement by said rubbing member to produce a surface effect damping force in at least one of the first or second directions.

### FIELD OF THE INVENTION

The invention relates to a door closer and more particularly the invention relates to a door closer where the movement of the closer is controlled in part by employing a movable rubbing element operable in frictional or sliding contact with a contact member to produce damping forces as the rubbing element is displaced during opening and closing of the door.

### BACKGROUND OF THE INVENTION

Conventional door closers generally employ a fluid such as air or hydraulic fluid to control the displacement of the movable closer components when the door is opened and then closed. Ultimately the fluid affects the resistance experienced when the door is opened or closed. The fluid resistance is typically greater during closing to prevent the door from slamming. Conventional door closers typically use either the stored energy of a spring member or the compressed hydraulic fluid or air to controllably return the door to the closed position. Schematic representations of conventional strut type, single arm and double arm door closers are respectively provided in FIGS. 1, 2 and 3.

FIG. 1 illustrates a simple strut type door closer 10 that hydraulically or pneumatically provides damping forces during the extension and retraction of the strut member. The tubular housing 12 is fixed to the door jamb or wall 14 and door 16 by respective bracket members 18 and 20 which are connected to the housing ends. The brackets are fixed to the wall and door by conventional fasteners. Door 16 is hingeably connected to the jamb by a plurality of hinges 22. One hinge is shown in the broken view of FIG. 1. The door closer 10 includes a piston member (not shown) that is movable linearly through the chamber defined by the tubular housing 12 and a spring located in a portion of the chamber so that during operation as the door is opened the strut is extended and the piston is displaced linearly to one end of the housing 12 and the spring is compressed. When the door operator releases the door, the spring forces the piston to the opposite end of the housing causing the strut to retract as the door is returned to the closed position. A fluid such as air is forced through an orifice to provide damping to control the door through the closing cycle.

Conventional single arm and double arm overhead door closers 30 and 32 are illustrated respectively in FIGS. 2 and 3. Overhead closers generally include a motion control unit 34 fixed either to the door, wall, or door frame and a link configuration that joins the control unit to the door, wall or door frame. For example, in the single arm closer shown in FIG. 2, the control unit is located in the door frame 33 which may also be referred to as the door header or jamb with the first end of single link 36 connected to an output shaft of the control unit 34 and the second end of link 36 movably located in U-shaped channel 42 located along the top of door 38. As the door sweeps through its range of motion the second link end moves through the channel. In the double arm closer 32 shown in FIG. 3 the control unit 34 is mounted on the door 37 and links 40a and 40b join the unit 34 to the bracket 39 fixed to the door frame 41. The first end of link 40a is fixed to bracket 39, the first end of link 40b is fixed to control unit input shaft 44 and the links are hingeably joined at their second ends.

A longitudinal sectional view of control unit 34 is provided in FIG. 4. The control unit 34 is enclosed by housing 46 which defines chamber 47. The ends of the housing are closed by removable end caps 48 and 49. A volume of fluid such as hydraulic fluid or air is included in the housing chamber. Pinion 50 is mounted along the length of input shaft 44 which is rotatable about axis 5 1. As shown in FIG. 4, the ends of the input shaft 44 extend outwardly from the longitudinal sides of housing 46. The pinion is adapted to mesh with linear rack 52 that is moveable in chamber 47 along longitudinal axis 53. Pistons 54 and 55 are fixed to the ends of the rack to be moveable with the rack. The endplates include one or more apertures or tracks 56 therethrough which provide means for displacing the hydraulic fluid or air through the chamber. Under varying conditions of piston displacement and direction of motion, occasionally check valves 63 are installed in piston member 54 to permit easy door opening. Housing 46 includes fluid passages (not shown) with adjustable orifices. The pistons and check valve cause the fluid to be pushed through these passages when the door is closed. A pair of concentric coil springs 57 and 58 are located in the housing chamber between plate 55 and the plate 60 of a conventional spring tensioning mechanism 59.

As the door is opened, movement of the first end of link member, 36 or 40a rotates the shaft 44 resulting in rotation of pinion 50 which causes rack 52 to move in the direction of arrow 61. Continued opening of the door results in compression of springs 57 and 58 as the rack is displaced. The fluid is forced through passages 56, in direction 62 as the rack is moved. The fluid forces check valve 63 to open permitting the fluid to pass through the piston 54.

When the door is released, the check valve 63 closes the passageway 56, springs 57 and 58 bias the rack in direction 64. The fluid is forced through housing orifices (not shown) in direction 61. The forced fluid flow controls the speed at which the door is closed.

There are a number of problems associated with known door closers. The control housings of conventional door closers contain expensive and complex seals which are prone to failure, and as a result, the fluid leaks from the housing. The control units must be regularly maintained to ensure that the check valve and orifices are set correctly to provide the desired opening and closing motion. If the control units are not properly adjusted the door closers will not operate in the required manner resulting in doors that open too fast or close too quickly. Additionally, known closures like the single and double arm overhead closures described above comprise complicated designs with a large number of moving component parts. Such complicated closers are difficult and expensive to manufacture, assemble and repair.

The foregoing illustrates limitations known to exist in present devices and methods. Thus, it is apparent that it would be advantageous to provide an alternative door closer directed to overcoming one or more of the limitations set forth above. Accordingly, a suitable alternative door closer is provided including features more fully disclosed hereinafter.

### SUMMARY OF THE INVENTION

The present invention represents a substantial departure from conventional door closers as illustrated in FIGS. 1-4 that use a fluid such as air or hydraulic fluid to provide damping to the door closer. The door closer of the present invention incorporates an elastomeric or polymeric material in combination with either viscous and/or friction damping to provide damping control forces as the door is opened and closed. As the description of the preferred embodiments of the invention proceeds, such elastomeric/polymeric friction damping performance shall be referred to as surface effect damping. For purposes of disclosing the best mode for practicing the invention the term surface effect damping shall be understood to generally mean non-hydraulically actuated damping that is the result of relative motion between two surfaces. The relative motion may be linear, or non-linear, one or both of the surfaces may move relative to one another and one or both of the surfaces may be elastomeric or polymeric. The resultant surface effect damping is comprised of friction, viscous and hysteretic damping force components. The resultant surface effect damping may be comprised of one, two or all of the damping force components which may be of the same or different magnitudes.

In the broadest sense the door closer of the present invention may be generally described as a door closer for controlling the movement of a door where the door closer includes an input member, movable in response to movement of the door, the input member being movable in a first direction and in a second direction; return means for moving the input member in the second direction; and damping means for controlling the movement of the input member, the damping means comprising: a rubbing member movable in the first and second directions, and a body for engagement by said rubbing member to produce a surface effect damping force.

In a first aspect of the present invention door closer, the rubbing member has an active friction producing area, and the damping means includes means for varying the damping forces supplied by said damping means by varying the active friction producing area of the rubbing member.

In a second aspect of the present invention door closer, the damping means provides variable damping forces during operation of the door closer by varying the compression of the rubbing member as a function of the displacement of the rubbing member.

In a third aspect of the present invention door closer the rubbing member is adapted to bulge as it is displaced, and wherein the damping means provides variable damping forces during operation of the door closer by varying the amount the rubbing member is bulged as a function of the direction of movement of the rubbing member.

In a fourth aspect of the present invention door closer the rubbing member has a cross sectional area, and the body has a variable cross section, and wherein the damping means provides variable damping forces that are a function of the location of the rubbing member relative to the body along the path defined by the body.

The input member may be comprised of any suitable component such as but not limited to a shaft, a rack and pinion or a cam.

The return means may be comprised of a steel or elastomeric spring which may be further comprised of a torsion spring, a shear spring, a buckling spring, a coil spring or a compression spring.

The door closer of the present invention may be rotary acting or linearly acting.

The closer of the present invention may be comprised of a strut, single arm or double arm door closer.

Due to the vast number of combinations of input members, damping means and return means possible as well as the flexibility and adaptability of the surface effect concept, a number of preferred embodiments of the present invention door closer are presented hereinbelow.

The foregoing and other aspects will become apparent from the following detailed description of the invention when considered in conjunction with the accompanying drawing figures.

### BRIEF DESCRIPTION OF THE DRAWINGS

FIG. 1 is a schematic representation of a strut type door closure shown mounted in combination with a partially broken away door.

FIG. 2 is a schematic representation of a single arm overhead door closer shown mounted in combination with a partially broken away door.

FIG. 3 is a schematic representation of a double arm overhead door closer shown mounted in combination with a partially broken away door.

FIG. 4 is a longitudinal sectional view of a typical schematic of the control unit of the single arm and double arm overhead door closures of FIG. 2 and FIG. 3.

FIG. 5 is a schematic block diagram that generally represents the door closer of the present invention.

FIG. 6 is a schematic representation of a linearly acting door closer with the input member, damping means and return means arranged along a common linear axis.

FIG. 7 is an isometric view of a first embodiment door closer with the housing removed.

FIG. 8 is a top view of the first embodiment door closer of FIG. 7.

FIG. 9 is a longitudinal side view of the door closer of FIG. 7.

FIGS. 10a and 10b illustrate an alternate embodiment damping element for the first embodiment door closer of FIGS. 7-9.

FIGS. 11a, 11b and 11c are schematic representations of a damping element for a second embodiment door closer of the present invention.

FIG. 12 is a top view of a third embodiment door closer of the present invention.

FIG. 13 is a longitudinal sectional view taken along line 13-13 in FIG. 12.

FIG. 14 is an alternate configuration damping element for the third embodiment door closer of the present invention.

FIG. 15 is an alternate configuration return means for the third embodiment door closer of the present invention;

FIG. 16 is a schematic representation of a damping element for a fourth embodiment door closer of the present invention.

FIG. 17 is a schematic representation of a fifth embodiment door closer of the present invention.

FIG. 18 is a schematic representation of an alternate embodiment damping element for the fifth embodiment door closer of the present invention.

FIG. 19 is a longitudinal section view of a damping element of a sixth embodiment door closer of the present invention.

FIG. 20 is a sectional view taken along 20-20 of FIG. 19.

FIGS. 21a-21d are schematic representations of alternate embodiment linearly acting damping means.

FIG. 22 is a schematic representation of a door closer that includes an input member, linearly acting return means and rotary acting damping means.

FIG. 23 is a longitudinal sectional view of a seventh embodiment door closer.

FIG. 24 is an alternate configuration damping element for the seventh embodiment door closer.

FIG. 25 is another alternate configuration damping element for the seventh embodiment door closer.

FIG. 26 is a third alternate configuration damping element for the seventh embodiment door closer.

FIG. 27 is a sectional view taken along line 25-25 of FIG. 24.

FIG. 28 is a damping element of an eighth embodiment door closer of the present invention.

FIGS. 29a, 29b and 29c schematically illustrate torsional spring elements for use in combination with a rotary acting door closer of the present invention.

FIG. 30 is a schematic representation of an ninth embodiment door closer of the present invention.

FIG. 31 is a schematic representation of a tenth embodiment door closer of the present invention, the tenth embodiment door closer being rotary acting and including a resilient band wrapped partially around the input member.

FIG. 32 is a sectional view taken along line 32-32 of FIG. 31.

FIGS. 33a, 33b and 33c are schematic representations of a eleventh embodiment door closer of the present invention showing the damping element in first, second and third positions.

FIGS. 34a and 34b illustrated first and second positions of a twelfth embodiment door closer of the present invention.

### DETAILED DESCRIPTION OF THE PREFERRED EMBODIMENTS

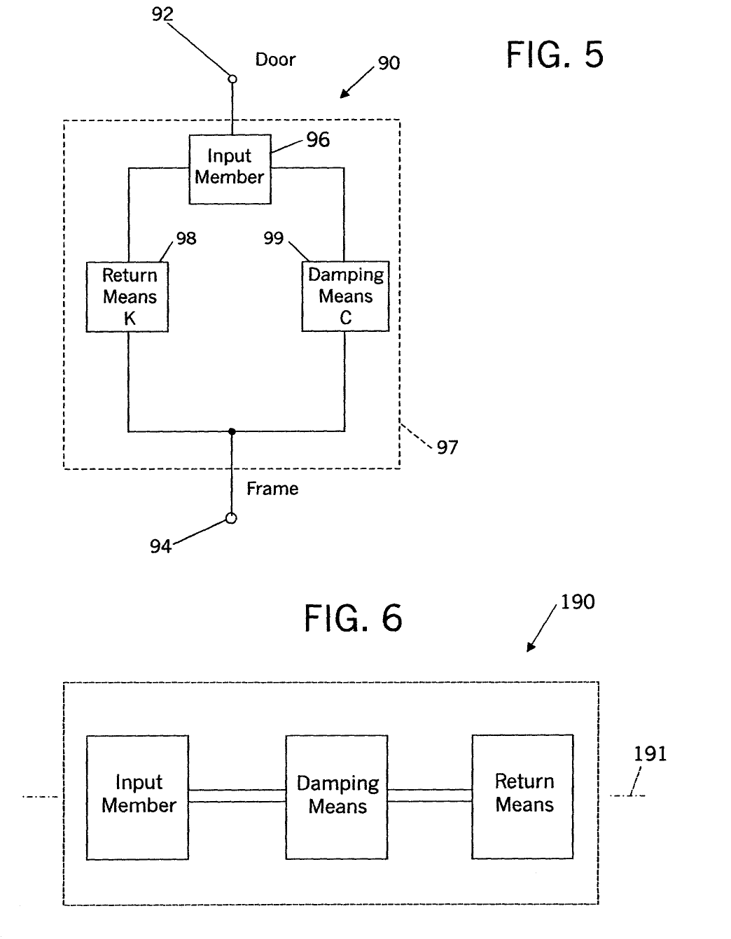

Now turning to the drawing figures wherein like parts are referred to by the same numbers in the several views, FIG. 5 is a schematic representation of the door closer of the present invention. Before describing the specific details of the twelve preferred embodiments of the present invention the door closer provided hereinbelow, FIG. 5 is generally provided to present the various elements that may be combined to comprise the door closer of the present invention.

Door closer 90 is fixed to a door (not shown) at attachment point 92 and is fixed to the door frame or the wall surrounding the door (not shown) at attachment point 94. The door closer is fixed to the frame and door in a conventional manner well known to one skilled in the art. An input member 96 is adapted to receive an input motion when the door is opened and closed and typically the input motion is in the form of rotary displacement. The input member may be any suitable device or apparatus that is adapted to be displaced in response to opening and closing of the door, and more specifically the input member may be comprised of a conventional shaft, rack and pinion arrangement or a cam member.

A return member or spring 98 and damping means 99 are mechanically arranged in parallel so that as the door is opened the force of resistance provided by the return means increases as the return means is compressed and the damping provided by the damping means 99 is negligible. Conversely as the door is closed, the energy stored by the return means as it is compressed during opening is released to reverse the motion of the input member and close the door, and the damping supplied by the damping means 99 is increased to control the motion of the door closer so that the door is closed in a controlled manner. The input member, damping means and return means are enclosed by housing 97.

The return means may be any suitable energy storage device and may include for example, a metal coil spring, a linear shear spring, a torsion shear spring, a buckling spring, a tension spring or a compression spring. The linear shear, torsion shear, buckling, tension and compression springs may be made from a suitable ceramic, metallic, elastomeric or composite material.

The damping means includes a rubbing element and a contact member and usually a suitable lubricant either impregnated in one or both of the rubbing element and contact member or between the element and member. When the rubbing element is in contact with the contact member surface effect damping is produced. The supplied friction damping may be tuned or adjusted for a specific door by changing the surface effect damping forces that are produced as the elastomeric or polymeric rubbing element is displaced past the contact member which may be defined by a housing, plate or contoured surface for example.

In the present invention the surface effect damping supplied by the damping element may be adjusted in a number of ways. For example the damping force may be adjusted by varying the rubbing element's active friction producing area as a function of displacement or direction of motion; or by varying the amount the rubbing element is compressed as a function of element displacement or direction of motion or velocity; or by varying the amount the element is bulged as a function of input force and/or direction or by varying the amount the element is compressed as a function of the diameter of the element and the direction the element is moving; or by varying the type of surface contact between the rubbing element and contact member for example sliding contact and from sliding or rolling or from relative motion at all, as a function of input force or direction. Each of these methods for adjusting the surface effect damping forces will be described in greater detail in conjunction with the detailed descriptions of the eleven preferred embodiments provided hereinbelow. The damping forces may be greater when the door is opened or when the door is closed.

It should be understood that any suitable combination of input members, spring members and damping means may be used to provide the required opening and closing door motion. Additionally, it is also possible to provide a door closer that includes an input member in combination with a single member that provides the requisite spring forces and damping forces during door displacement. The specific embodiments disclosed hereinafter are made for purposes of describing the best combinations or modes for practicing the door closer of the present invention.

### Linearly Acting Door Closers

A linearly acting door closer 190 is illustrated schematically in FIG. 6. As shown in FIG. 6, the input member, damping means and return means are linearly acting and for purposes of the first embodiment of the present invention are linearly aligned along axis 191 with the damping means being connected to both the input member and return means. Specific embodiments illustrating door closers having a linearly acting arrangement of the input member, damping means and returns are described hereinbelow. Generally, for the linearly acting door closer of the present invention, the input member may be comprised of a suitable rack and pinion, cam, rotating shaft, cable, mechanical linkage or other mechanism or device that converts rotary motion to linear motion. The damping means and return means of linearly acting door closers are linearly acting devices and the return means may be comprised of a tension, compression, shear or buckling spring. Additionally, although the damping means is illustrated between the input member and return means, the elements of the linearly acting door closer may be arranged in any suitable orientation and configuration.

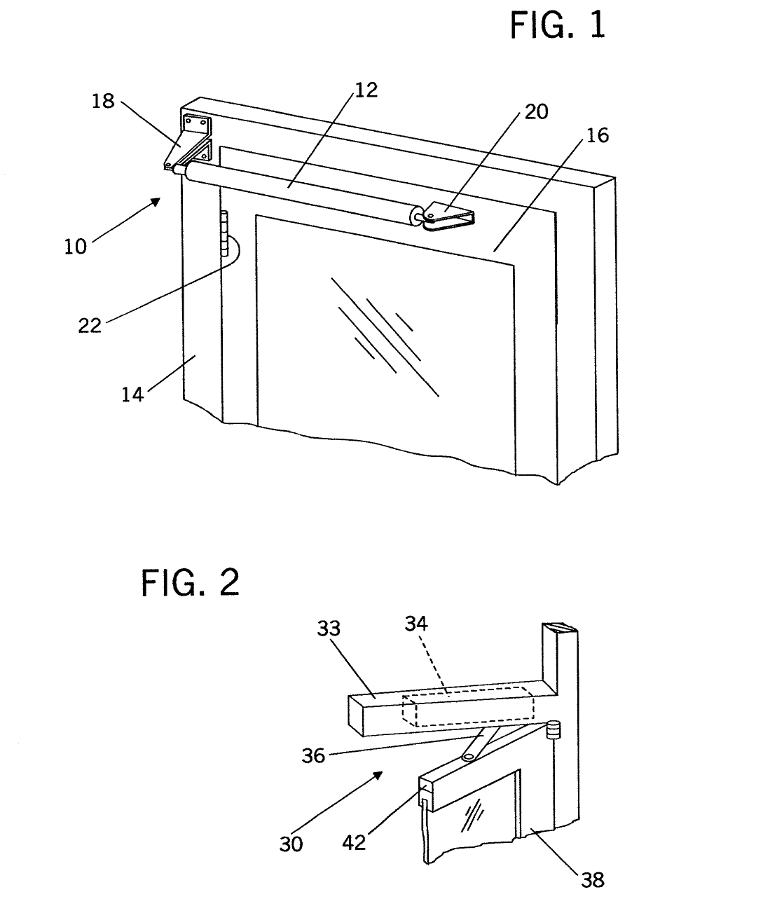

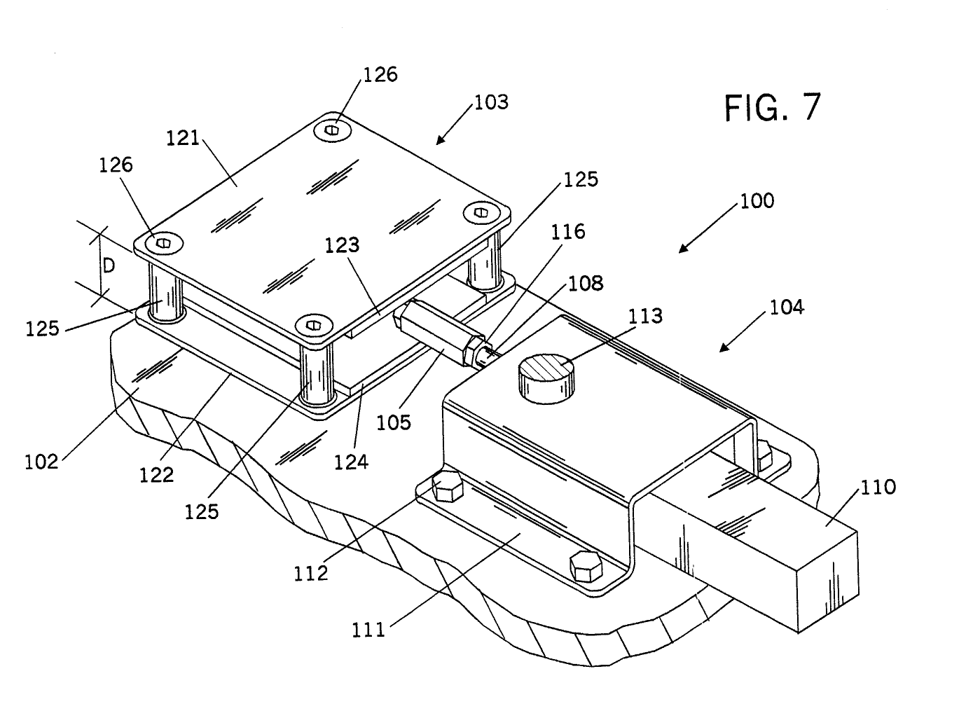

Turning to the specific embodiment linear acting door closers, a first embodiment closer 100 is illustrated in FIGS. 7-10b. The first embodiment door closer is fixed to door 102 which is shown broken away. The door closer may be of the type and oriented in the manner shown in FIGS. 1, 2 and 3. As the description proceeds it should be understood that the door closer may be mounted to the door, which may include the door header, door panel itself or any other structure associated with the door unit.

Closer 100 includes damping means 103, and return assembly 104 that are coupled by sleeve 105. The return assembly is well known to one skilled in the art of door closers and comprises a rotary to linear displacement mechanism or input member that converts the rotary motion inputted to shaft 113 and pinion 107 to linear motion by a linear rack 106 that meshes with the pinion. The rack includes a linear gear that engages the pinion member 107. Rod 108 is fixedly attached to one end of the rack and return means or spring member 109 is fixed to the opposite rack end.

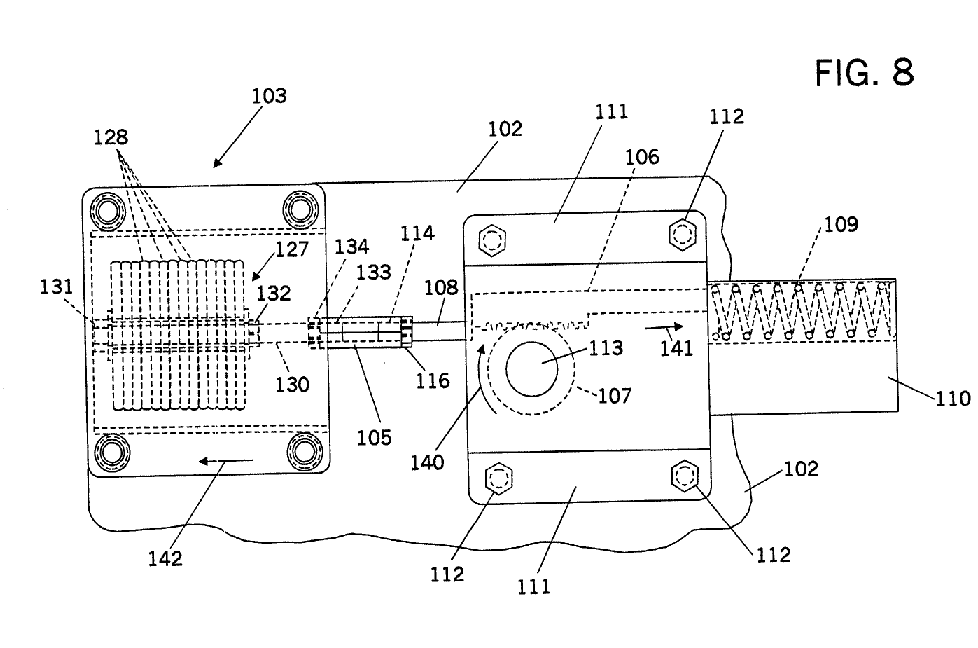

The return means may be a coil spring as represented schematically in FIG. 8 or any other well known suitable spring. The return means 109 is located in housing 110 and the opposite end of the spring is fixed or is otherwise adapted to remain seated on the housing during movement of the rack.

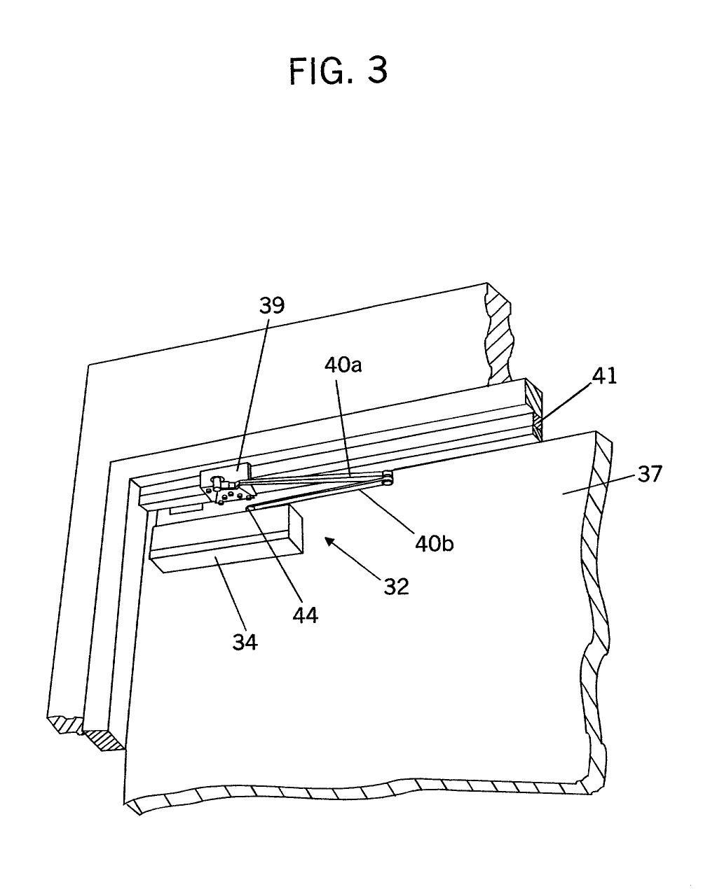

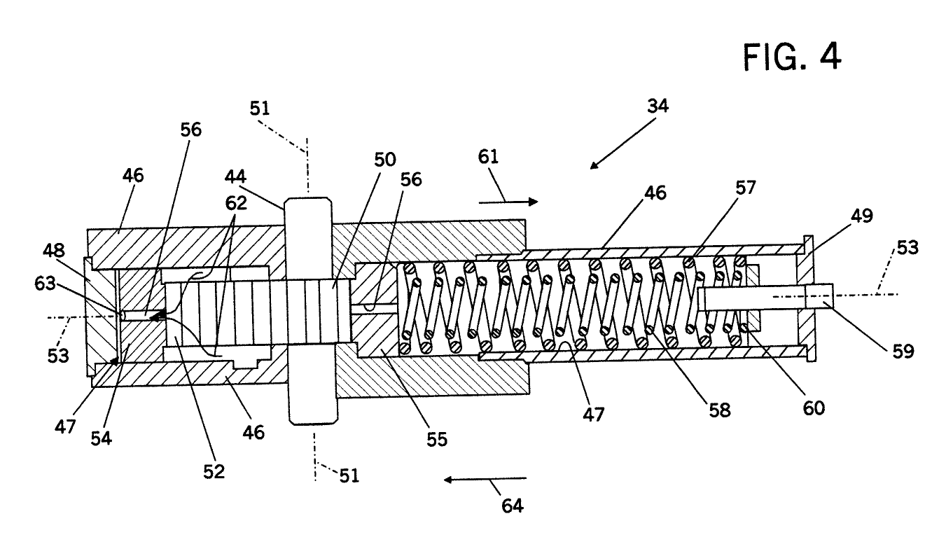

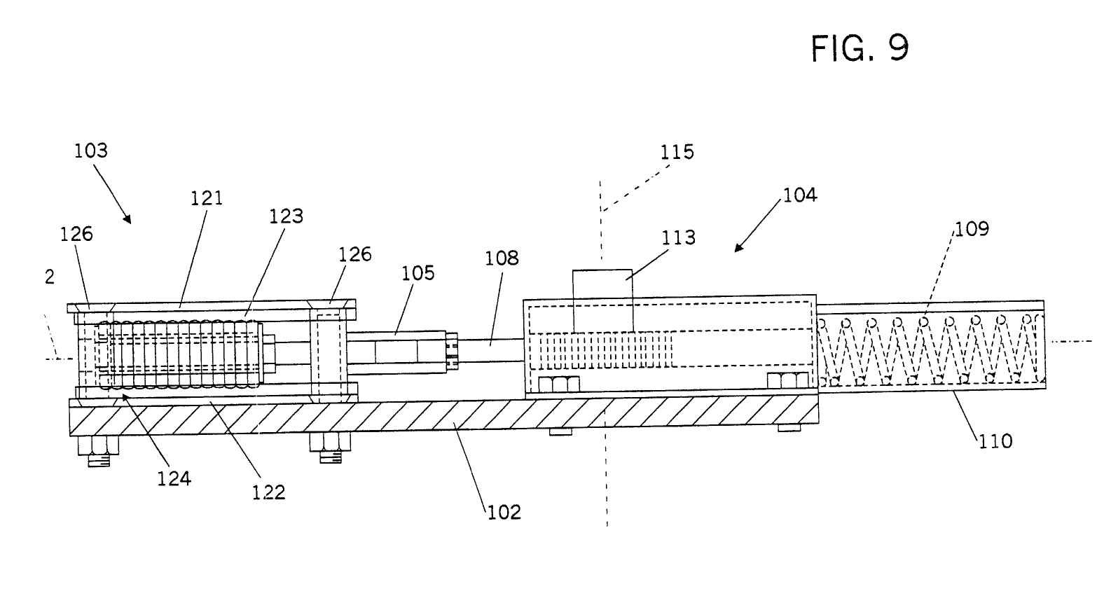

The pinion 107 is fixed to input shaft 113 and is rotatable with the shaft about axis 115. See FIG. 9. One end of the input shaft 113 extends outward from housing 111 and is adapted to be connected to door closer connection members like members 36, 40a and 40b shown in FIGS. 2 and 3.

The rack and pinion may be enclosed by housing 111 to protect the moving elements from undesirable particulate matter that may collect on the closer. Conventional fastening members 112 such as bolts or screws attach the housing 111 to the door 102.

Coupling 105 is threadably connected to the rod end 114. A nut member 116 is also threaded to the rod end and against the end of the coupling. See FIGS. 7 and 8.

Damping means 103 is connected to return assembly 104 by coupling 105 so that the rubbing element 127 and rack 106 move together. Generally, the damping means 103 is used to control the energy release of the spring 109 when the door is closed. The surface effect damping forces supplied by the damping means are a function of the displacement of the rubbing element 127.

The damping assembly comprises first and second plates 121 and 122 with first and second resilient contact members 123 and 124 fixed to one side of the respective plates. The resilient members may be fixed to the first and second plates using any suitable adhesive or other means. For purposes of describing the first preferred embodiment of the invention the means for fixing the members 123 and 124 to the plates is an epoxy adhesive.

Columns 125 provide initial spacing between the first and second plates 121 and 122, and conventional fasteners 126 are passed through the plates and sleeves and serve to fix the assembly 103 to the door 102. As shown in FIG. 7 when the fasteners are tightened the plates 121 and 122 are initially separated by a distance D and are substantially parallel. The distance D may be changed to provide greater or decreased surface effect damping during operation of first embodiment closer 100 by tightening down or releasing the connection members. Additionally, any combination of fasteners may be tightened or loosened to effect the desired damping. All the fasteners may be tightened or loosened the same amount to maintain parallelism between the plates and resultant constant surface effect damping or variable surface effect damping may be provided by tightening or loosening the fewer than all of the fasteners. For example, the ends of plates 121 and 122 nearest the coupling 105 may be drawn together by only tightening the fasteners at the plate ends nearest the coupling.

A rubbing element or damping pack 127 is movable between the plates. The damping pack includes a plurality of indenters or elements 128 located side-by-side along rod 130. The indenters preferably have a rectangular shape and are made from nylon, but it should be understood that the indenters may be made from any suitable material or have any suitable cross section such as a circular cross section for example. The indenters are maintained stationary along rod 130 between retainer nuts 131 and 132 and are maintained substantially perpendicular to longitudinal axis 192 as the rubbing element 127 is displaced along the axis 192. It should be understood that in an alternate embodiment of closer 100 the indenters 128 could be comprised of a resilient material and the layers 123 and 124 could be comprised of a nylon or metallic material.

End 133 of rod 130 that extends outward from the plates 121 and 122 is threadably connected to coupling member 105. Nut 134 like nut 116 is tightened against coupling member 105. Nuts 116 and 134 maintain the coupling member 105 stationary during operation of the door closer. The displacement of rubbing element 127 may be adjusted by tightening or loosening the nuts 116 and 134 to adjust the length of rods that are coupled to the coupling member 105.

Operation of the first embodiment door closer 100 will now be described.

The damping assembly 104 provides damping to the door closer unit 100 that is a function of the displacement of the damping pack 127. Additionally, the damping supplied by the damping means is typically greater when the door is closed than when the door is opened.

During opening, the link 36, 40a or 40b moves and rotates shaft 113 in direction 140 about axis 115 causing rack 106 to move in direction 141 towards spring 109, thereby compressing the spring. Damping means 103 provides damping as the pack is moved. As the door is opened the indenters are pulled in direction 141 and tend to contract and as a result do not substantially engage the resilient contact members 123 and 124 or produce any significant surface effect damping. When the door is opened the desired distance and the door is released the rubbing element 127 is forced in direction 142 by the return means 109 as the return means returns to its extended length. The damping means 103 provides damping and thereby controls the extension of spring 109. As the pack 127 is pushed in direction 142, the indenters bulge outwardly and engage the resilient layers 123 and 124 to provide surface effect damping.

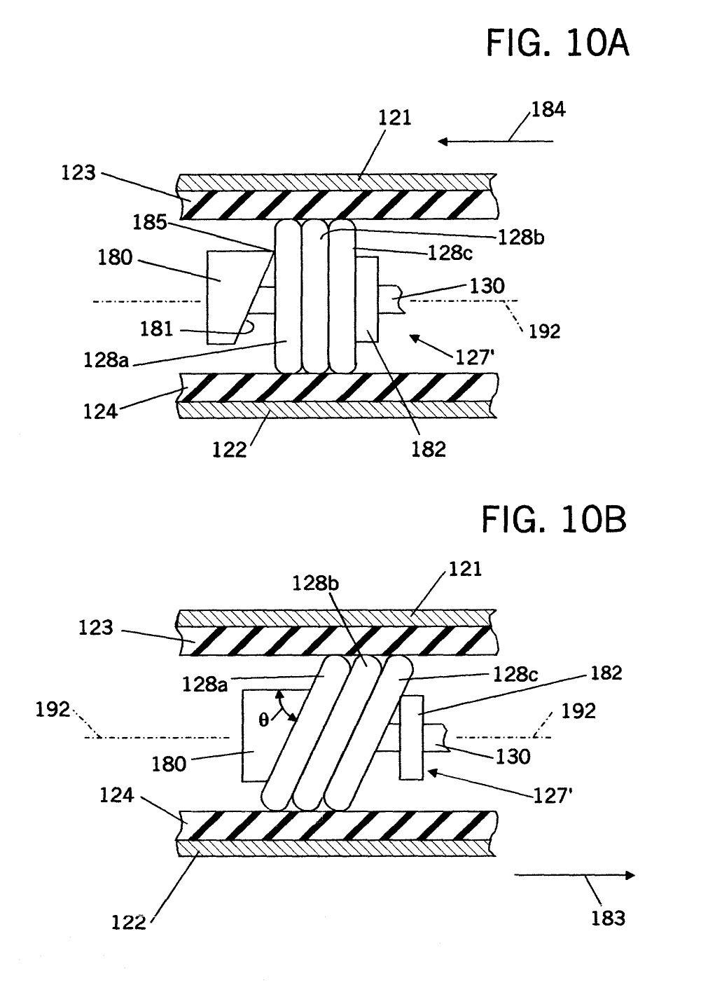

An alternate embodiment damping pack 127′ for door closer 100 is shown in FIGS. 10a and 10b. The damping pack comprises a plurality of elements 128 that are maintained in a fixed location along the length of shaft 130 between wedge stop 180 and collar 182. The upper and lower indenter surfaces engage resilient surfaces 123 and 124 in the manner previously described hereinabove however unlike the elements 128 of the rubbing element 127 of the elements of rubbing element 127′ may reorient at an angle relative to axis 192 when the rubbing element 127′ is moved in direction 183, and the indenters 128 are substantially perpendicular to axis 192 when the element 127′ is displaced in direction 184. The damping forces provided by damping pack 127′ are a function of the direction and distance the damping pack is displaced.

Although three discrete elements 128 are shown in FIGS. 10a and 10b it should be understood that any suitable number of elements may be located between the wedge and collar. The collar 182 is connected to the shaft 130 along the length of the shaft in a conventional manner such as by a threaded connection. The collar may be a conventional nut. The wedge 180 is fixed to one end of rod 130 in a well known, conventional manner such as by threadable attachment or weld, and the stop wedge has a downwardly and inwardly stopping surface 181 that faces the indenter members 128a, 128b and 128c. The stopping surface is oriented downwardly and inwardly in the direction the damping pack is displaced when the door is opened. This direction is identified in FIG. 10b by arrow 183.

Depending on the application., the indenters may be located between the wedge and collar side-by-side with no gaps or “play” between the indenters so that damping is provided when the door is closed even during the smallest displacements. Alternatively, a permissible amount of play or gap may be provided between the indenters so that during small displacements no damping is provided even when the door is closed. For purposes of disclosing the alternate embodiment damping pack 127′ the damping pack does not include any play between the indenters.

Turning to FIG. 10b, as the door is opened, the damping pack 127′ is displaced by rack and pinion 106, 107 in the manner previously described hereinabove. As the rubbing element 127′ is displaced in direction 183, the indenters are forced clockwise about upper edge 185 until indenter 128a is located against support surface 181 with the other indenters side-by-side with each indenter being oriented at the angle of the surface 181, identified in FIG. 10b as •. Indenter 128c is in abutment with collar 182. In this orientation during opening of the door a small portion of the surface of the indenters is in engagement with the elastomer layers 123 and 124 and therefore the damping force supplied by damping pack 127′ during door opening is minimized as the rubbing element 127′ is pulled in the direction 183. When the door is closed, and the damping pack is pushed in direction 184, the indenters are oriented substantially vertically as shown in FIG. 10a and the surface area in contact with elastomer walls 123 and 124 is maximized. The elements bulge outwardly into further engagement with the layers 123 and 124. Therefore, the surface effect friction force supplied to the door closer is also maximized.

The surface effect damping that is provided may be altered by changing the distance separating or the relative parallelism between plates 121 and 122. Damping pack 127 provides damping forces that are a function of the displacement of pack 127 and damping pack 127′ provides directional damping that is a function of the direction the pack is displaced. The damping forces supplied by pack 127′ are minimized during the opening stroke and is maximized during the closing stroke. In door closer 100, the compression of the rubbing elements may also vary as a function of the displacement of the element by changing the distance and parallelism between the plates.

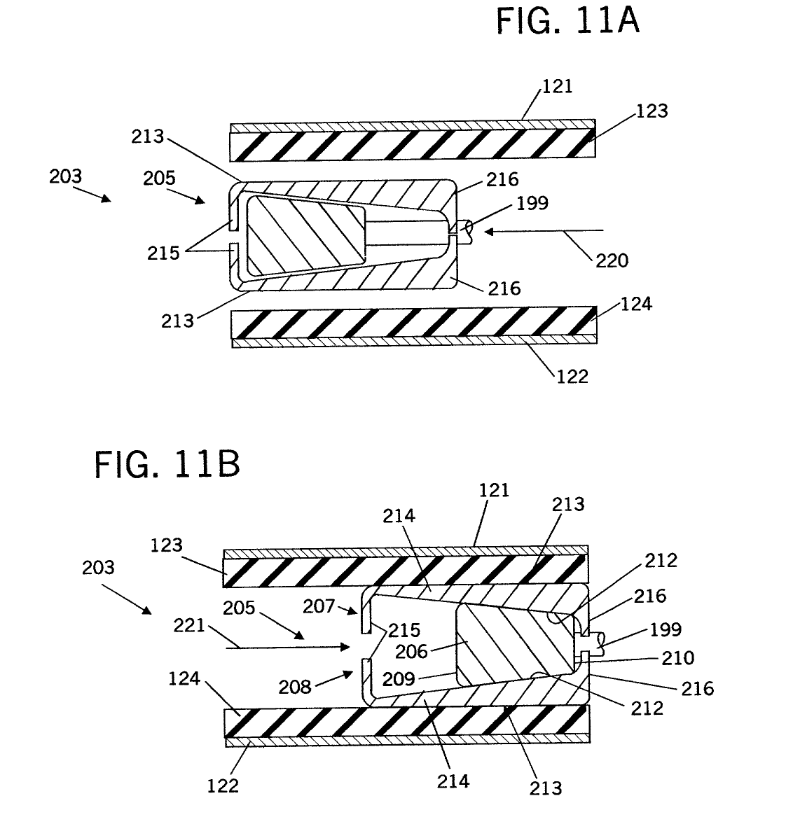

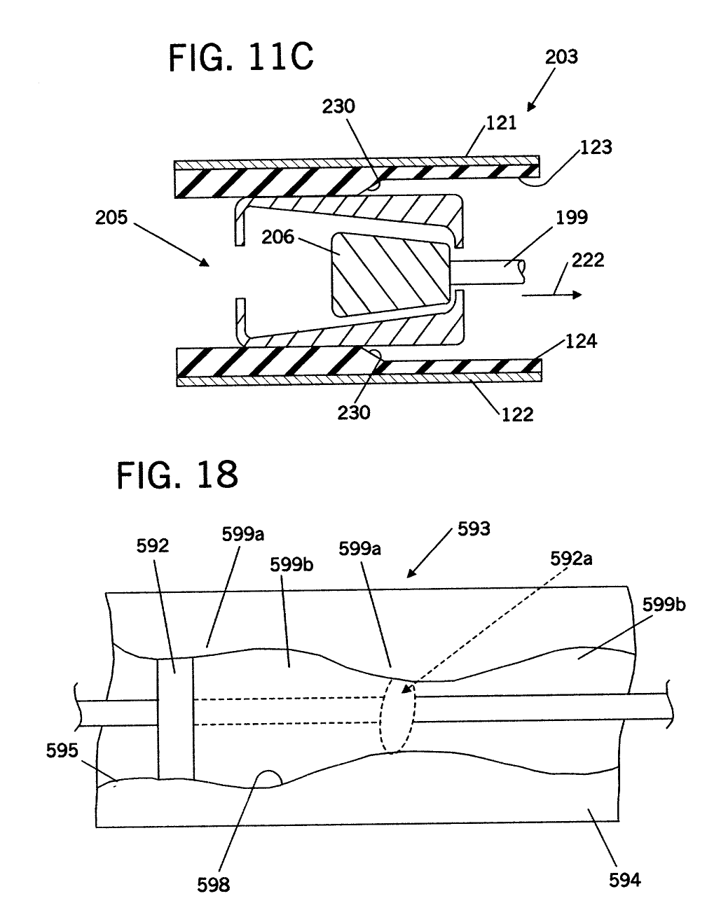

Damping means 203 for a second embodiment door closer is illustrated in FIGS. 11A, 11B and 11C. The damping assembly may be mated with the return assembly 104 previously described above in the description of the first embodiment door closer 100. Additionally, the damping assembly 204 includes previously described contact members comprised of plates 121 and 122 with resilient contact members 123 and 124 attached to one side of the plates 121 and 122. In use, the resilient contact members are directed inwardly and the plates 121 and 122 are directed outwardly. Previously described fasteners 126 and columns 125 maintain the required spacing and parallelism between the plates in the manner described hereinabove with the first embodiment door closer 100.

Rubbing element 205 includes a wedge 206 located between first and second clamp plates 207 and 208. As shown in FIGS. 11A and 11B, the rubbing element is located between the resilient layers 123 and 124 with the clamp plates 207 and 208 adjacent the contact members 123 and 124. The wedge and clamp plates extend laterally substantially the entire lateral lateral dimension of the plates 121 and 122. The clamp plates and wedge are made out of a nylon, metal or other suitable non-resilient material. For purposes of describing the damping means 203, wedge 206 may be bonded to clamp plates 207 and 208 through an elastomeric connection.

The wedge 206 has a trapezoidal cross section with a first parallel face 209 joined to a second parallel face 210 by contact faces 211 and 212. The faces converge as they extend from face 209 to face 210. The wedge is made integral with rod 199 which in turn is connected to coupling 105 as previously described in conjunction with the first embodiment door closer 100. Alternatively, the rod may be directly connected to the input member.

The clamp plates 207 and 208 are substantially similar and comprise substantially flat outer surfaces 213 adapted to engage the surfaces of resilient contact members 123 and 124; inner surfaces 214; and inwardly directed wedge stop members 215 and 216 along the peripheral edges of the plates. The stop members 216 include cutouts (not shown) that permit the rod 199 to be passed through the mated clamp plates. The inner surface is tapered downwardly and inwardly as it extends from stop 215 to stop 216, and at substantially the same angle of convergence as wedge surfaces 211 and 212.

Turning to FIG. 11A, as the door is opened, the input shaft 113 and pinion 107 are rotated causing the rack 106 to be displaced moving the wedge and clamp plates as a single unit in a first direction which for purposes of describing the second embodiment is identified by arrow 220. During door opening minimal damping is supplied to the door closer. In FIG. 11A the distance separating each of the surfaces 213 and the adjacent resilient layer is exaggerated for clarity. In operation the clamp plate surfaces 213 and adjacent contact members 123 and 124 are separated by a very small gap or are in light contact. The normal forces on the clamp plates are minimal when the door is opened. As shown in FIG. 11A, the damping element travels in direction 220 as a compact unit.

FIG. 11B illustrates the operation of rubbing element 203 as the door is closed. As the door is closed, the wedge 206 and clamp plates are displaced between the resilient members 123 and 124 in direction 221. As the wedge and clamp plates are translated between stationary members 123 and 124, the contact surfaces 212 ride against the inner plate surfaces 214 and thereby urge the clamp plates outwardly and as a result, surfaces 213 contact the adjacent member 123, 124 to damp the motion of the plates and wedge and ultimately the extension of the closer return means or spring. The wedge and plates continue in direction 221 until the return means is fully extended and the door is closed. Typically the wedge surface 210 is in contact with the stop members 216. As the plates are urged apart by the wedge, the normal surface effect damping forces acting on the plates 207 and 208 increases as the plates travel between the contact members 123 and 124 to the position shown in FIG. 11B, thus increasing the surface effect damping forces.

When the door is again opened, the wedge travels in direction 220 and the clamp plates 207 and 208 move away from the contact members 123 and 124 toward the wedge 206.

The resilient contact members 123 and 124 fixed to plates 121 and 122 do not have to have the constant thickness as shown in FIGS. 11A and 11B. The members may include a taper or another type of surface transition 230 that extends laterally completely across the resilient layers. The transition affects the distance separating the resilient layers and the differences in the separation distances affects the surface effect damping forces experienced by the clamping plates and wedge 206 as the unit moves in direction 222. In the rubbing element position shown in FIG. 11C, approximately half of the surfaces 213 of the clamping plates are in contact with the resilient member therefore, the plates experience less surface effect damping force with the transition than if the entire surface were in contact with the resilient layers. Once the clamping plates and wedge clear the transition region, little damping force is supplied to the plates and wedge. Although a linear transition is shown and described it should be understood that any suitable transition geometry and any configuration of transitions may be included along the length of resilient layers 123 and 124.

Thus the surface effect damping provided by damping means 203 varies based on the direction the rubbing element is traveling and also is a function of the distance traveled. Additionally, the surface effect damping may be varied by varying the active friction producing area of the rubbing element. For example, the surfaces 213 may be modified to include one or more friction producing protuberances along all or a portion of surface 213.

A third embodiment door closer 300 is illustrated in FIGS. 12-15. The third embodiment door closer includes housing 301 that defines a chamber 302. Laterally extending depressions 310 are provided along the exterior of at least one longitudinal wall of housing 301 and by their inclusion provide relative flexibility to the housing section located between the depressions. In this way, the depressions serve as hinges joining the flexible housing section to the less flexible sections of the housing. Additionally, a series of spaced apart laterally extending semicircular protrusions 311 are provided along interior surfaces of opposite longitudinal housing walls between the depressions. The protrusions may also be referred hereinafter as contact members. As shown in FIG. 12 rubbing element 307 is located in the housing chamber 302 between the protrusions and as will be described in greater detail herein below, surface effect damping forces are provided to the door closer in the portion of the housing that includes the hinges, protrusions and damping element. The hinges permit the space between the housing and damping element and the relative angle therebetween to be adjusted by the fasteners. Thus the third embodiment door closer provides damping as a function of displacement.

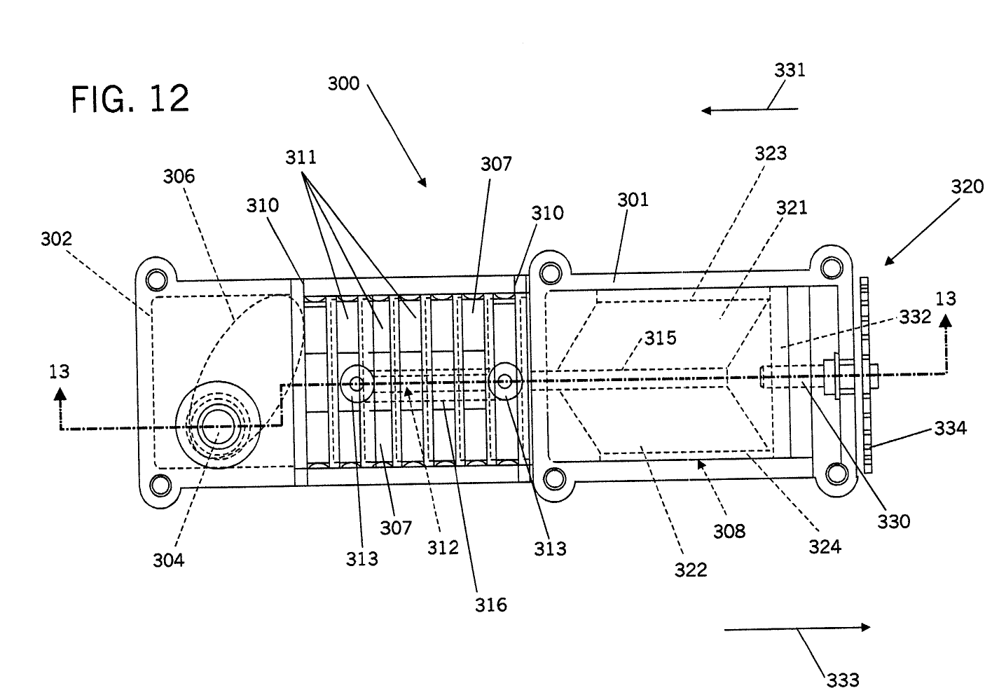

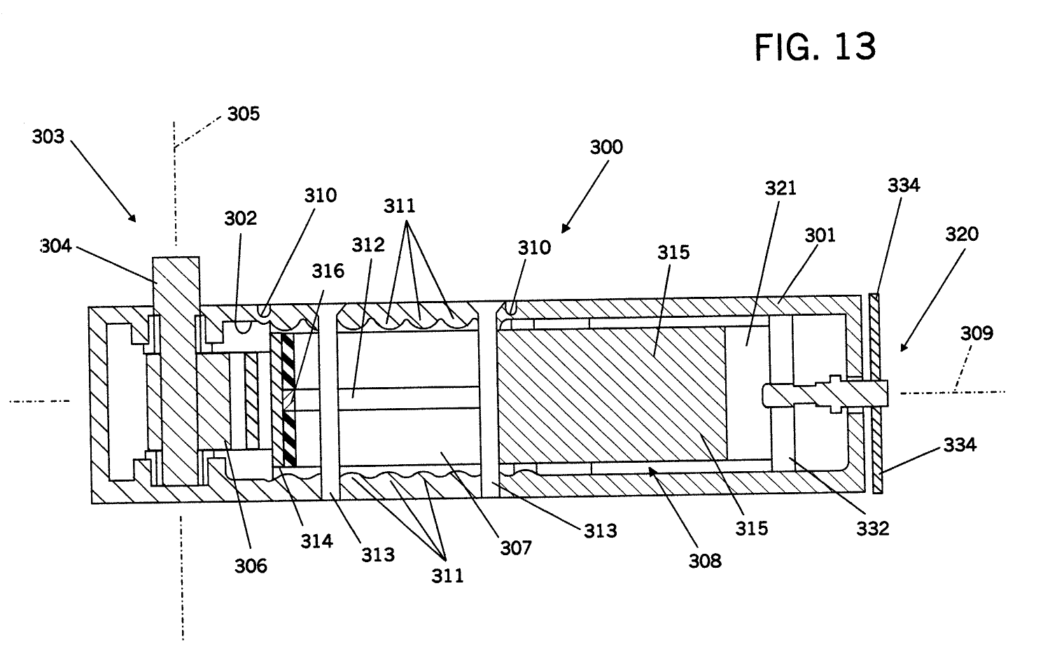

Tightening a fastener 313 increases the surface effect damping through that segment of the stroke and loosening the fastener decreases the surface effect damping. Although depressions are shown in FIGS. 12 and 13 it should be understood that the living hinges may assume any suitable flexible configuration including a bellows cantilevers etc. The fasteners may be used in combination with springs or other devices.

Input member 303 comprises a shaft 304 rotatable about axis 305 and a cam member 306 fixed to the shaft to be rotatable with the shaft during opening and closing of the door. A person skilled in the art understands that the cam is provided the necessary shape required to produce the motion and damping necessary to control the opening and closing door motion. As shown in FIG. 12, for purposes of describing the third preferred embodiment door closer of the present invention the cam is provided an oval shape. A rack and pinion may replace cam 306.

As previously mentioned, rubbing element 307 is located in the housing chamber 302 between the input member 303 and return means 308. When the cam engages the damping element, the damping element is displaced generally along longitudinal axis 309. The damping element may be comprised of any suitable material but preferably the member is comprised of a resilient material such as a rubber for example. A rigid contact plate 314 is fixed to one end of element 307. The cam 306 contacts the plate during operation of closer 300. Plate 316 is included in element 307 which is formed around the plate. Slot 312 extends through the damping element and center plate 316 and is adapted to permit fastening members 313 to be passed through the element. The fasteners extend through the housing and protrusions 311. See FIG. 13.

To increase damping the fasteners are tightened bringing the protrusions closer to or into engagement with the damping element. Damping is decreased by unscrewing or otherwise loosening the fasteners. Only minor tightening or loosening displacements of the fasteners are required to effect changes in the damping forces supplied. The hinge depressions 310 permit the housing walls to be drawn together and relaxed apart when the fasteners are tightened and untightened.

Return means 308 comprises a double shear element located between the damping element 307 and adjustment or preload mechanism 320. The return means is directly connected to the center plate 316 in a conventional manner such as by a weld connection or by suitable conventional fasteners. Resilient members 321 and 322 are joined to center plate 315 plate and outer plates 323 and 324 by an adhesive such as an epoxy adhesive.

Preload mechanism 320 provides a preload to the return means. The preload mechanism includes a shaft 330 having a threaded end located in the housing and a second end located outside the housing with a preload plate 332 threadably connected to the first end and a knurled dial 334 fixed to the second shaft end. Rotation of the dial in first and second directions causes the plate to be moved toward and away from the outer plate members 323 and 324. The preload on the means 308 may be increased by rotating the dial about axis 309 to move the plate into engagement with the outer plates. The outer plates are moved parallel to axis 309 in direction 331. When the means 308 is preloaded the center plate remains stationary. To decrease the preloading the dial is rotated in the opposite direction and the plate is withdrawn in direction 332 and the outer plates 323 and 324 move in the same direction.

During operation, as the door is opened and input member is rotated clockwise about axis 305, the cam is moved into engagement with contact plate 314 of damping element 307. The damping element is displaced in direction 333. A small magnitude damping force is produced during the opening. However as the damping element is displaced, energy is stored in return means 308.

As the door is released and closed, the stored energy is released to push the rubbing element and thereby cause the element to move in direction 331. As a result, the member bulges into engagement with protrusions 311. This engagement produces surface effect damping that controls the rate that the energy is released from the return means 308.

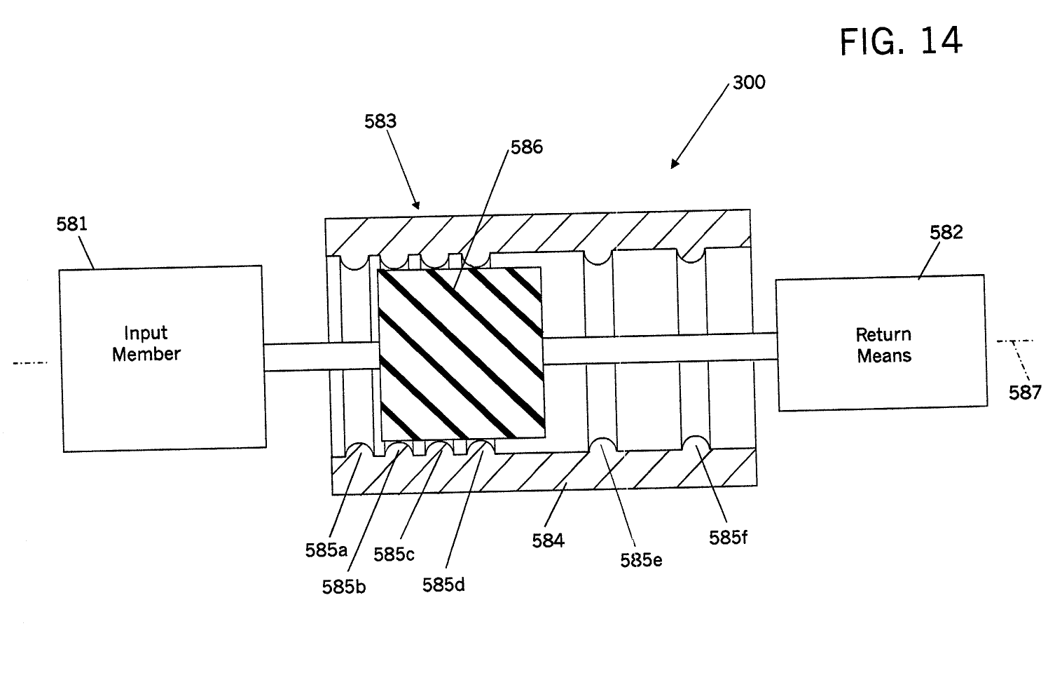

An alternate embodiment damping means for the third embodiment door closer is illustrated in FIG. 14. The door closer 300 includes suitable input member 581 and return means 582 that are operably connected to damping means 583 in a conventional manner. Damping means 583 includes a hollow cylindrical housing 584 with a series of spaced apart annular protuberances 585a, 585b, 585c, 585d, 585e and 585f formed along the inner surface of the wall. The protuberances are spaced along the wall as required to provide the required damping to the closer as the door is swept through its opening and closing motion. The annular protuberances provide frictional contact with the resilient member 586 as it travels linearly through the fixed housing 584 along axis 587. The resilient member may be a solid mass such as a cylinder or may be comprised of another suitable configuration such as member 307 for example. The damping means 300 provides a variable contact surface that produces damping forces that are a function of the distance traveled by the resilient member 586 through the housing 584.

As shown in FIG. 14 the protuberances are not spaced equidistantly along the inner housing wall. Rather protuberances 585a-585d are grouped proximate each other while protuberances 585e and 585f are spaced away from the grouped members 585a-585dd. By varying the spacing of the protuberances along the path traveled by resilient element 586, the movable element's active friction producing area is varied as a function of displacement and therefore the damping force supplied is by damping means 583 is also made variable. In the present damping means 583, the damping force produced is greatest when protuberances 585a, 585b, 585c and 585d are in contact with resilient member 586.

The annular protuberances are shown as having a semicircular cross section however it should be understood that the protuberances may include any shape cross section required to produce the required damping forces. Additionally, the housing may include any number of protuberances arranged in any suitable configuration and grouping.

It should be understood that although the member 586 is shown as being resilient or elastomeric and the housing 584 is shown as non-elastomeric in an alternate embodiment the housing could be elastomeric and the movable member could be non-elastomeric. Also, the housing is shown as fixed with the resilient member being movable through the housing. However the resilient member may be held stationary and the housing made movable in an alternate embodiment of closer 300.

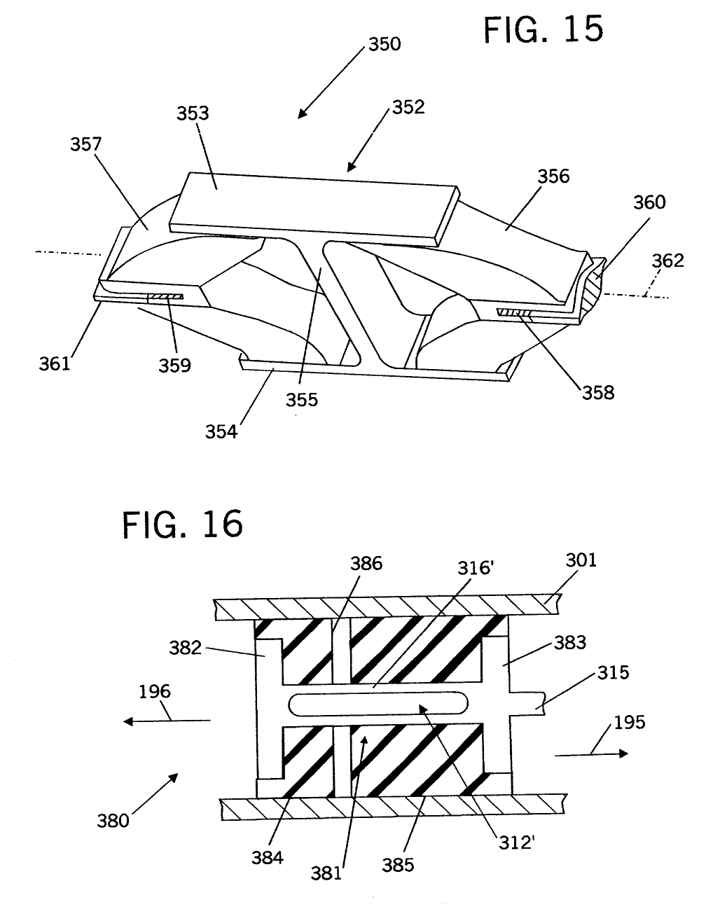

A return means 350 for a fourth embodiment door closer of the present invention is illustrated in FIG. 15. The return means comprises a rigid frame 352 having an H-shape with parallel arms 353, 354 joined by body 355 between the arm ends. The frame may be made from any suitable rigid material including steel for example. V-shaped resilient members 357 and 356 are located between the ends of arms 353 and 354 with the ends of the resilient members attached to the arms. The resilient members are made from any suitable elastomer and are fixed to the arms using any suitable means such as an adhesive. Resilient members 356 and 357 include respective slots 358 and 359 that are adapted to receive a respective load plate 360 and 361. In use, load plate 360 is attached to the housing 301 and the second load plate 361 is made integral with plate 316 of damping element 380 shown in FIG. 16. Alternatively, the load plate 360 could be made integral with rubbing element 586 or rubbing element 203. A door closer 300 that includes alternate return means 350 does not include the preload mechanism 320 but would use a preload device that functions in the same manner as device 320. The load plates are displaced along axis 360 during operation of the door closer 300. The H-frame 352 slides in the housing chamber during operation As the load is applied the load plate 361 moves towards load plate 360 and the frame 352 also is displaced towards plate 360 at half the rate of plate 361.

An alternate embodiment rubbing element 380 for a fourth embodiment door closer is illustrated in FIG. 16. The rubbing element may be used in combination with the housing 301, input member 303 and return means 308 of the third embodiment door closer 300, previously described. The rubbing element comprises a unitary frame 381 that includes slotted plate 316′ with first and second spools 382 and 383 located at the plate ends. Discrete first and second resilient members 384 and 385 are molded or otherwise fixed to respective spools 382 and 383 and are separated by a gap 386. The rubbing element 380 is made integral with return means 308 by shaft connection315 as previously described.

As shown in the partially sectioned view of FIG. 16, the rubbing element is adapted for movement through housing 301 and the surface effect damping supplied by the damping element may be adjusted by tightening or loosening the fasteners 313 that extend through slot 312′ in the manner described hereinabove.

In operation, when the door is opened and cam 306 engages spool 382, the spool and member 384 are urged toward gap 386 and against the housing walls to increase the surface effect damping forces. As the element is moved in direction , the spool 383 and resilient member 385 are pulled in direction 195, placing the member 385 in tension and decreasing the diameter of member 385 and limiting the surface effect damping produced by the member 385. Surface effect damping provided during opening is supplied substantially by element 384. When the door is closed, the return means 308 releases the stored energy and moves the damping element 380 in direction 196. The resilient member 384 is placed in tension as it is moved indirection 196 and the member 385 is placed in compression, and as a result bulges into gap 386 and against housing walls to produce surface effect damping forces. The diameters of members 384 and 385 are the same however the axial length of the member 385 is greater than the axial length of member 384 so that movement in direction 196 when the door is closed, will produce damping forces that are greater than the forces produced during the opening of the door when the element is moved in direction 195. Therefore, by varying the compression and frictional surface area of members 384 and 385, the surface effect damping provided by the element 380 may be varied.

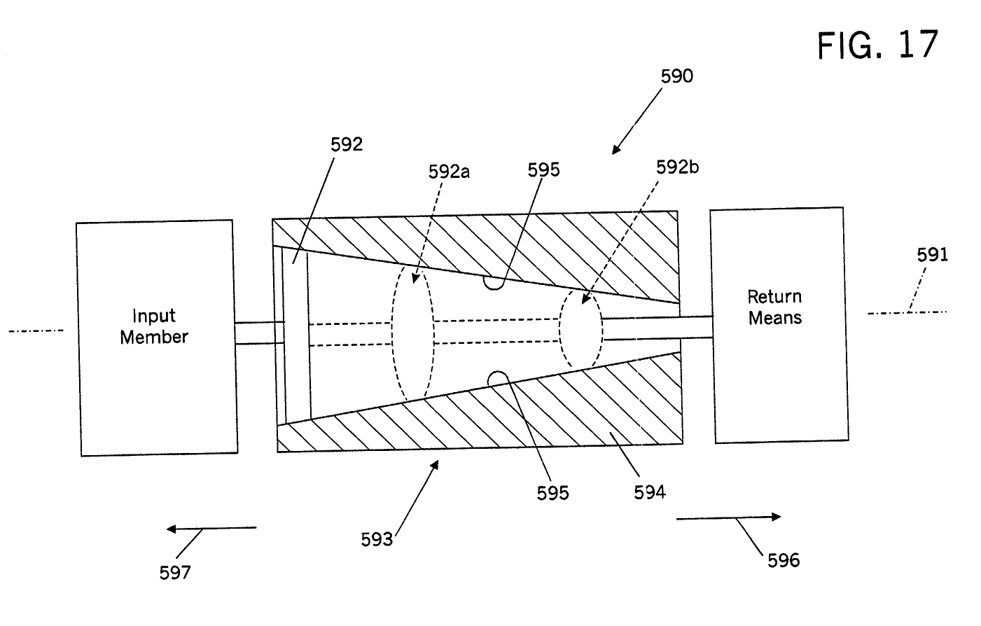

A fifth embodiment door closer is illustrated in FIGS. 17 and 18. The fifth embodiment door closer 590 includes damping means 593 that is operably connected to conventional input member 581 and return means 582 in a manner well known to one skilled in the relevant arts. As shown in FIG. 17, the damping means 593 is aligned with the input member and return means. In the damping means 593 of the fifth embodiment door closer 590, the damping forces provided are a function of the displacement and compression of the element 592 along the path of motion through housing 594.

Damping means 593 provides damping that is varied as a function of displacement along axis 591. The damping is varied by altering the amount the resilient elastomeric movable element 592 is compressed as a function of element displacement. As shown in FIG. 17, the fixed housing 594 of damping means 593 includes an inner wall 595 that is tapered inwardly in first direction 596. The tapered wall is substantially linear and is generally conical. As the movable element is displaced in direction 596, initially, the element 592 is compressed minimally, however as the element is displaced further the compressive forces acting on the element are increased and greater damping is provided by means 593. See elements 592a and 592b. When the door motion is reversed, initially the damping supplied is considerable and the damping decreases as the element is moved in direction 597.

The taper of wall 595 does not need to be linear. The angle of taper may vary, and the wall 595 could include a laterally extending step or transition from one angle to another. Additionally, as shown in FIG. 18, the inner wall 595 may include a contoured surface that is non-linear. As shown in FIG. 18 the alternate embodiment wall 595 includes hills and valleys 599a and 599b to respectively increase and decrease the compression of element 592, and ultimately the damping provided by means 593.

Additionally, the housing 594 may be comprised of two or more sections and may include means for varying the angle between the sections. The means may be comprised of a set screw or other conventional means for moving or reorienting a member.

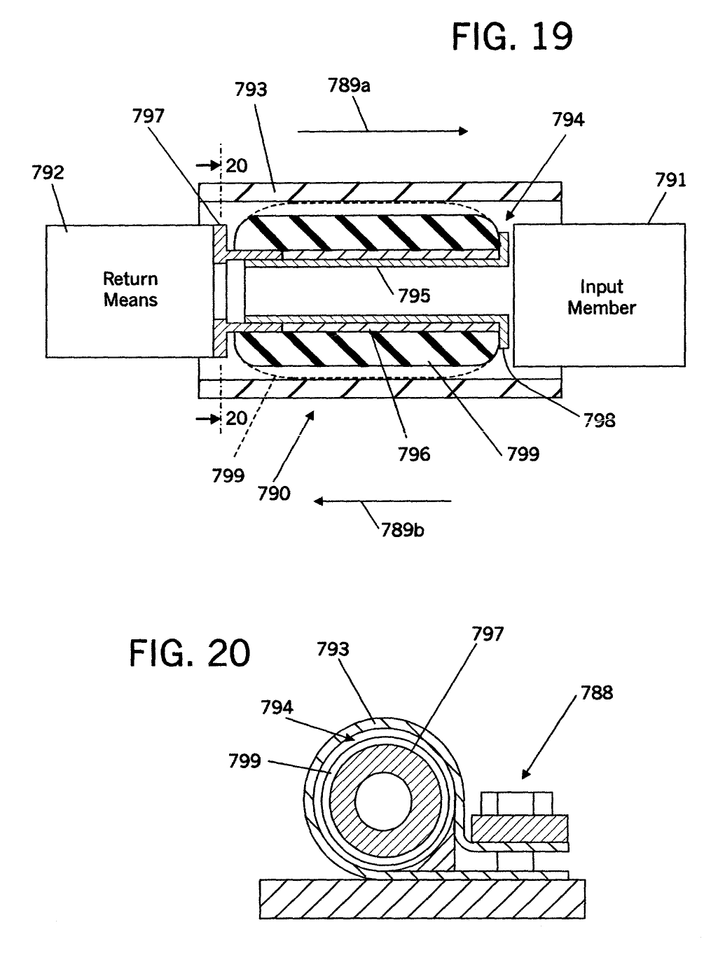

FIG. 19 illustrates a sixth embodiment door closer with an alternate configuration damping means 790. The damping means is operably and conventionally connected to conventional input member 791 and return means 792 so that the axes of operation are aligned. The damping means is described in U.S. Pat. No. 5,257,680 assigned to Lord Corporation of Erie, Pa., the terms of which are incorporated herein by reference. Generally, as shown in FIG. 19, damping means 790 is comprised of a hollow cylindrical housing 793 and damping element 794 further comprised of inner and outer elongate tubular members 795 and 796 where the inner member is nested in the outer member. The housing may be a C-clamp as shown in FIG. 20 or other conventional type housing. As shown in FIG. 20, the housing diameter may be altered by making an adjustment to bolts 791. Additionally, a plurality of damping means 790 may be included in a closer unit. The tubular members 795 and 796 include respective flanges 797 and 798. The flanges are provided at opposite ends of the respective tubular members. Resilient element 799 substantially encloses the outer tubular member 796 between the flanges. During operation, as the door is closed the return means displaces the outer tube in direction 789a and flange 797 is moved into abutment with resilient member 799. Initially, as the element is displaced in direction 789a, the resilient member begins to bulges into contact with the inner wall of housing 793. See dashed font representation of element 799. The damping force is a function of the volume bulged into contact with the housing 793.

When the door is opened, input member 791 displaces inner tube 795 in direction 789b. The flange contacts the end of outer housing 796 and a portion of member 799. The contact between flange 798 and member 799 is minimized resulting in less bulge volume in contact with the housing and lower damping forces when the door is opened. The closer 790 provides variable damping forces by varying the bulge of the member 799. The volume bulged varies based on whether the door is being opened or closed.

Damping means 790 represents one means for providing variable damping forces by varying the bulge volume. Other damping means may be used to provide damping that is a function of the change in the bulge volume. Such alternative damping means are described in the following United States patents assigned to Lord Corporation that disclose linearly and rotary acting dampers and the terms of the following patents are incorporated herein by specific reference. U.S. Pat. No. 5,720,369; U.S. Pat. No. 5,634,537; U.S. Pat. No. 5,486,056; U.S. Pat. No. 4,964,516; U.S. Pat. No. 4,957,279; and U.S. Pat. No. 4,706,946.

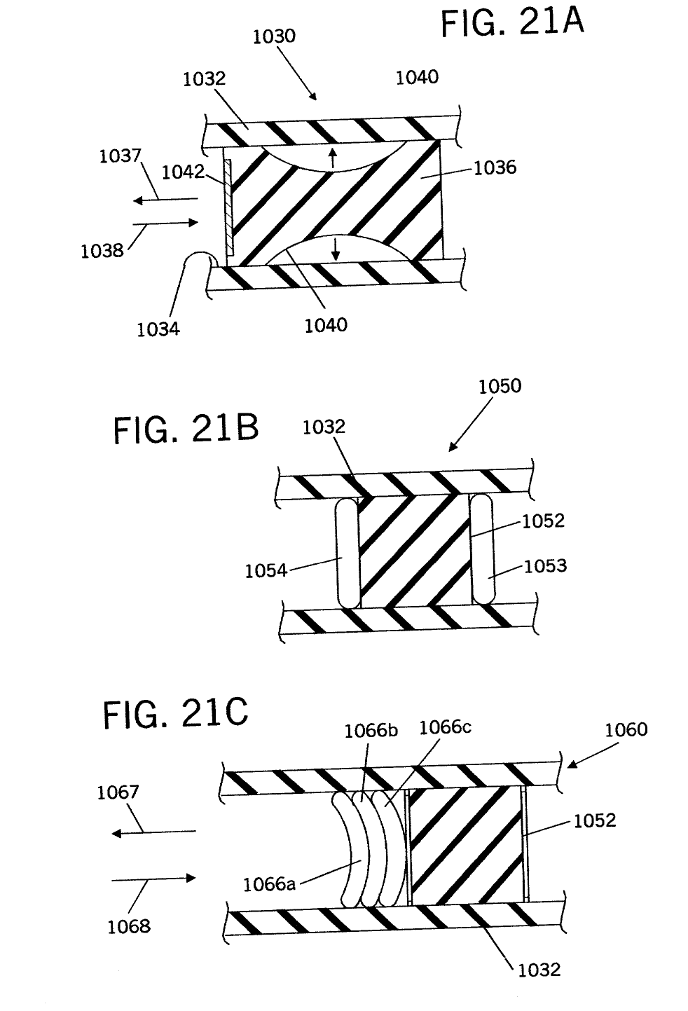

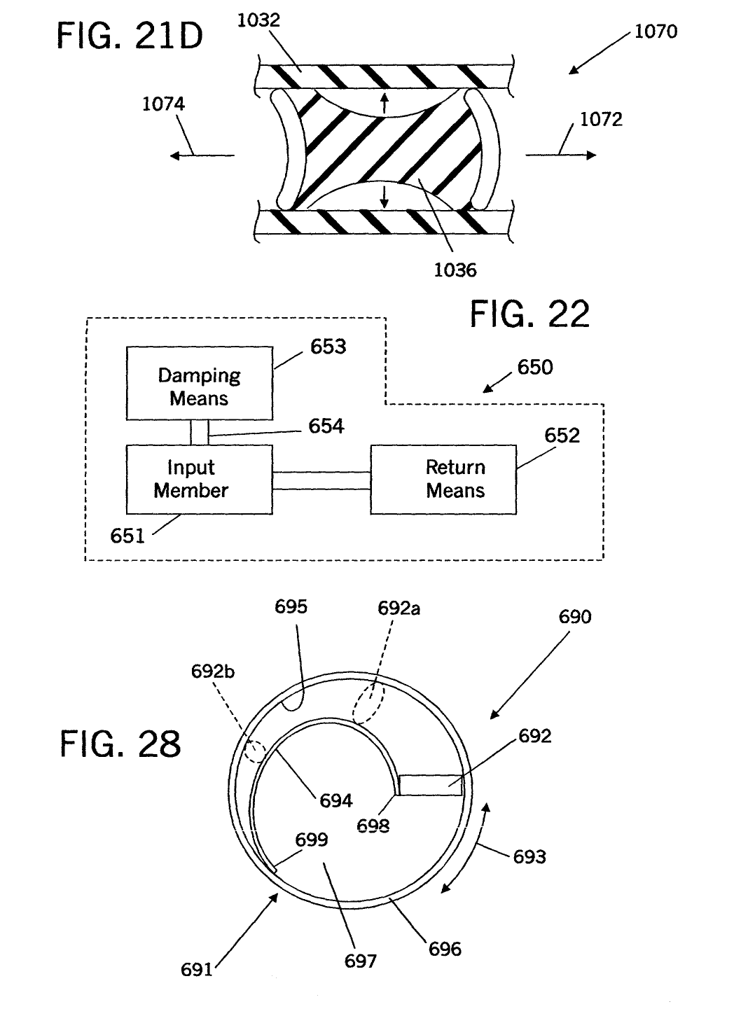

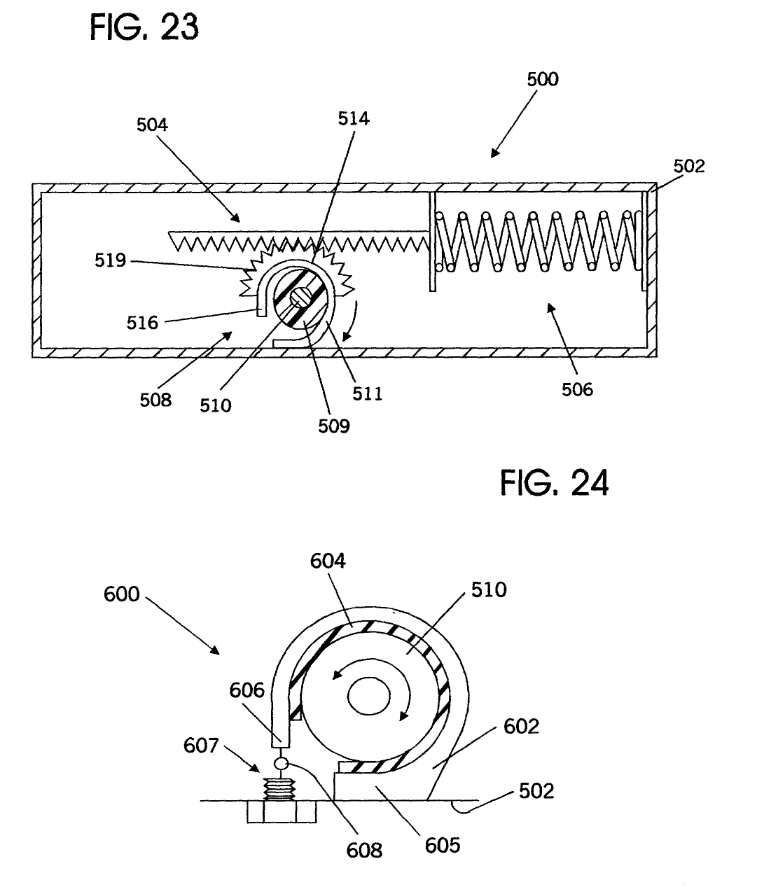

A number of alternate embodiment damping means are disclosed in FIGS. 21A, 21B, 21C and 21D. Each damping means may be coupled with any of the linearly acting input members and return means described herein. FIG. 21A discloses a damping means 1030. The damping means comprises a housing 1032 defining chamber 1034 with cylindrical rubbing element 1036 that is movable through the housing in directions 1037 and 1038. The body 1036 comprises a substantially hourglass shape. The wall of member 1036 is closely adjacent or in sliding contact with the housing wall. The rubbing element comprises an annular cutout portion 1040 that may bulge radially when the element is moved axially in direction 1038 A rigid contact plate 1042 is made integral with body 1036 at one body end. The damping provided is a function of the force applied and velocity of the member 1036. Both the rubbing element and housing are made from a resilient material.

When the member 1036 is moved in direction 1037 the body is in tension and little additional damping is provided as a result of bulging into recess 1040. When the body is displaced in direction 1038, the member is in compression as the contact plate is urged into the member body causing increased bulging into recess 1040 and against the wall of the housing.

Damper 1050 is also force and velocity dependant. The damper comprises a body 1052 that may be cylindrical or rectangular. The outer wall of the member 1052 is closely adjacent to the wall of housing 1032. The body 1052 is made from a resilient material. Contact members 1053 and 1054 are provided at each end of the body 1052. These members are made from a plastic and have a configuration like the configuration of the body. For example the members 1053 and 1054 may be rectangular or cylindrical. The periphery of the members are rounded. The rounded peripheral portions are in contact with the inner housing wall. As the member is moved in directions 1037 and 1038, the body bulges into contact with the housing wall. The greater the force that drives the rubbing member 1052 the greater the damping forces that are produced by damping means 1050.

Damping means 1060 comprises resilient body 1052 that is movable axially in directions 1067 and 1068 through housing 1032. The resilient body includes plates 1062 and 1064 that are made integral with the body. A plurality of cup members 1066a, 1066b and 1066c are stacked back-to-back in housing chamber 1033. Concave portion of member 1066c is in contact with body 1052 and the concave portion of cup members 1066b and 1066a are nested in the concave portions of cups 1066c and 1066b respectively. The outer peripheral portions of the cups are rounded and are in contact with the housing wall. The cup members comprise a hollow conical shape. The damping means 1060 provides directional damping. When the body and cups are moved in direction 1067, greater damping is provided as the peripheral portions provide resistance to the displacement 1067. When the cups and body are moved in direction 1068, damping is provided as the outer peripheral portions of the cups contact the housing however this contact does not provide the resistance to displacement provided in direction 1067.

Damper 1070 includes body 1036 with cup members 1066d and 1066e bonded to the ends of the body. The cups are bonded to the body using a conventional adhesive. Greater resistance to displacement and bulging of recess 1040 occurs when the body is moved in direction 1074 than when the body is displaced in direction 1072 for the reasons described in conjunction with damping means 1060 and 1030. Thus the damping forces produced by damping means 1070 is force and direction dependent.

### Rotary Acting Door Closers

FIG. 22 schematically represents a rotary acting door closer 650 that includes conventional input member 651 operably connected to return means 652 and damping means 653. The input member may be a single shaft or any suitable mechanical device as described above in conjunction with the linearly acting door closers. For example, the return means may be comprised of a discrete linear acting tension, compression, shear or buckling spring or may be a torsion spring. The torsion spring may be part of a single unit that comprises a torsional spring means and damping means. Specific embodiments illustrating door closers with torsionally acting damping means are provided hereinbelow. If a torsional spring is used with the damper the spring and damper will be coaxial rather than being located along axes that are generally perpendicular as shown in FIG. 18. If a torsional spring and damper are included in the closer, the input member may be eliminated because there would be no need to convert rotary motion to linear motion.

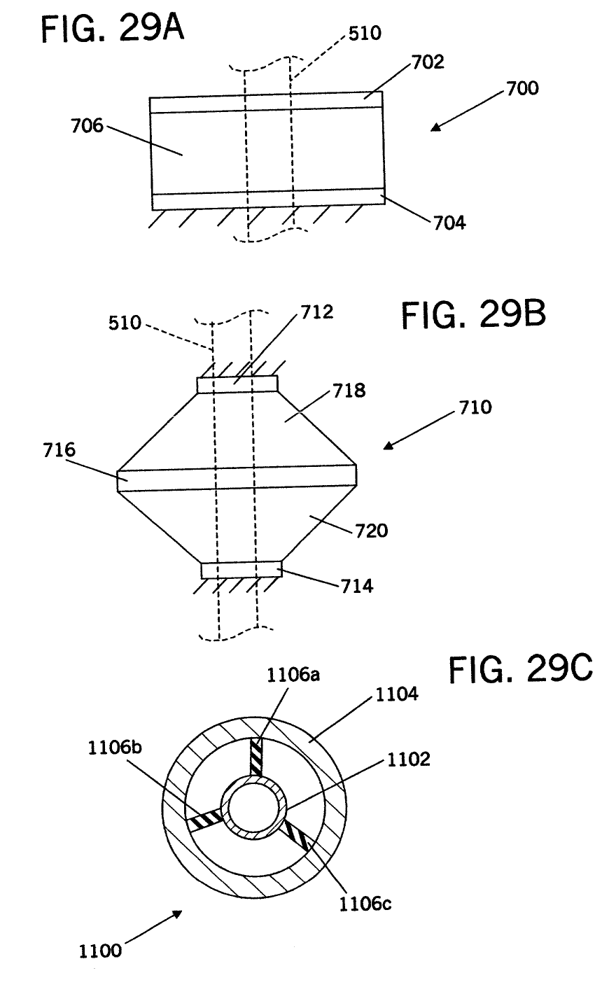

FIGS. 29A, 29B and 29C illustrate torsional spring elements that may be incorporated in rotary acting door closers of the present invention. In addition to the rotary acting door closers any of the previously described door closers that include a linearly displaced surface effect damping device may include a torsional spring element or return means that is attached to the input shaft coupled to the input member. In such a configuration the spring force is applied directly to the input shaft. FIGS. 29A-29C illustrate two possible configurations for such torsion spring members. Turning to FIG. 29A, the torsion spring 700 may be comprised of a pair of parallel circular plates 702 and 704 joined by an elastomeric element 706 where plate 702 is free to move with the input shaft 510 and a the second plate 704 is fixed to the closer housing or another stationary member. In this way, the spring resists the rotary motion of the input member. Alternatively as shown in FIG. 29B, the torsion spring 710 may be comprised of a pair of fixed outer circular plates 712 and 714, a movable middle plate 716 and elastomeric members 718 and 720 joining each outer plate to the middle plate. The input shaft 510 is coupled to the movable plate and passes through openings in the resilient members and plates. Rotary motion is resisted by the torsion spring in the manner previously described for spring 700. FIG. 29C shows a torsion spring 1100 that may be comprised of a centrally located elongate tubeform 1102 an outer cylindrical shell 1104 and a plurality of resilient radially extending ribs 1106a, 1106b and 1106c joining the tubeform and outer shell. The ribs are bonded to the shell and tube by a conventional adhesive.

A seventh embodiment door closer 500 is illustrated schematically in FIG. 21. Housing 502 encloses input member 504 and return means 506 which may respectively be a rack and pinion and metal coil spring as previously described in conjunction with the previous linearly acting embodiments of the present invention door closer. Damping member 508 is comprised of a resilient element 509 made from an elastomer bonded to an input shaft 510 that directly drives the pinion 519 of rack and pinion 504. A substantially C-shaped unitary damping band 511 substantially shrouds the resilient member. The band includes substantially semicircular portion 514 and substantially straight portions 516 and 518 at the ends of the semicircular portion. The contour of the elastomer and the control area and shape of the damping band 511 allow for tuning of the damping as a function of door displacement and/or velocity.

As the pinion rotates, the resilient element 509 travels inside the damping band 514. Minimal damping is supplied when the semicircular portion 511 is in contact with member 509 and substantial surface effect damping is provided as the pinion rotates the straight portions of the shroud into engagement with the resilient member.

An alternative damping means 600 for seventh embodiment door closer 500 is illustrated in FIG. 24. The input shaft 510 that is connected to a conventional input member, such as a pinion, is substantially surrounded by a C-shaped shroud 602 and a resilient friction layer 604 bonded to the inner wall defined by the shroud. The shroud has a first portion or leg 605 that is fixed to the closer housing 502 and a second portion or leg 606 that has a free end that is connected to a set screw or tensioning means 607 by link 608. In order to adjust the level of friction damping applied to the input member 510 the end 606 is either drawn closer to the housing 502 or moved farther from the housing by adjusting means 608. When the end 606 is drawn closer the friction layer is moved against the shaft 510 to increase damping and when the distance between the end 606 and housing is relaxed, the damping element is moved from the member 510 and the damping forces are decreased. A second adjusting means may be provided at end 605 and in such an embodiment both ends 606 and 605 may be drawn together to effect the damping forces supplied to the input shaft. 510.

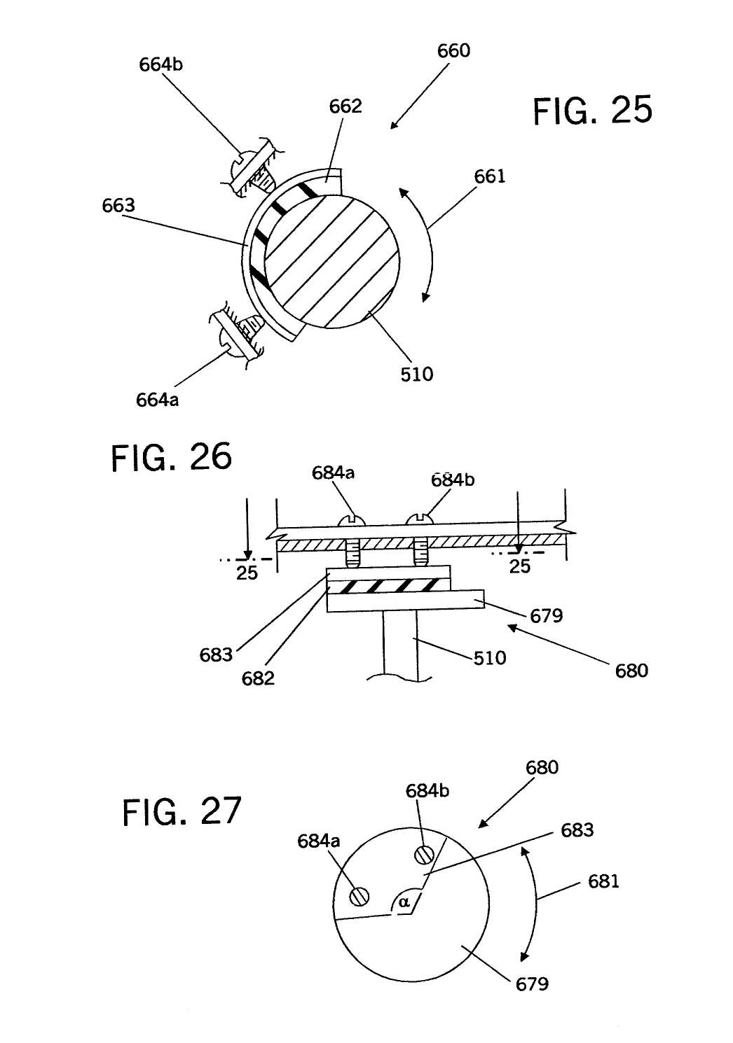

Damping means 660 comprising an alternate configuration damping element for seventh embodiment door closer is disclosed in FIG. 25. Input member rotating shaft 510 moves in directions 661as the door is opened and closed. Damping means 660 is comprised of a resilient member 662 sandwiched between an outer C-shaped shell 663 and the input member shaft 510. The outer shell in non-elastomeric and the member 662 is comprised of an elastomeric material. The resilient member assumes a C-shape when it is sandwiched between the outer member and shaft 510. The resilient member is shown as extending about 180° around the shaft however it should be understood that the member 662 may extend around the shaft at any suitable angle. By increasing or decreasing the active friction area and normal friction forces against the shaft 510, the surface effect damping forces will respectively be increased or decreased. The elastomeric element 662 can be connected to either shell 663 or the shaft 510.

Set screws 664a and 664b engage the outer member 663 between the edges of the member to produce a clamping force that maintains the member 662 between the outer member 663 and the shaft. The screws may be loosened or tightened to accurately adjust the clamping force and ultimately the damping force produced as the shaft is rotated.

FIGS. 26 and 27 illustrate an alternate configuration damping element 680 for the seventh embodiment door closer 500. A rotating disk 679 is attached to the end of input shaft 510 and rotates with the shaft. A resilient member 682 is sandwiched between top plate 683 and disk 679 by clamping means 684a and 684b that contact the outer plate 683 between the plate ends. As shown in FIG. 26, the resilient elastomeric member and the non-elastomeric outer plate are crescent shaped and extend at an angle, approximately 120° however the angle may be increased or decreased to effect the damping provided by damping means 680. Additionally, the clamping force and ultimately the damping supplied may be varied by tightening or loosening to further engage the plate 681 or release the screws from engagement with the plate.

In both damping means 660 and 680, the means may be modified to include any number of discrete rubbing members and plates sandwiching the plates between a moving input member. In damping means 680, the resilient member may be located on either side of the rotating disk for example.

Damping means for an eighth embodiment door closer is illustrated in FIG. 28. The damping means 690 is an example of a damping means for increasing the supplied damping forces by increasing compressive forces acting on resilient element 692 as housing 691 is rotated with the input shaft 510 in directions 693. The housing includes a channel of diminishing volume 695 that is defined along the bottom by flat disk 697 and laterally by raised inner wall 694 and the housing wall 696. The outer wall has a substantially constant diameter and the inner wall has a first free edge 698 located proximate the center of the disk with a second free edge 699 located tangent the wall 696. In this way the channel has a crescent shaped configuration that provides increased compression as the member approaches the second edge 699. See elements 692a and 692b. During operation, the rubbing element 692 is maintained stationary as the contact member or housing 691 is rotated.

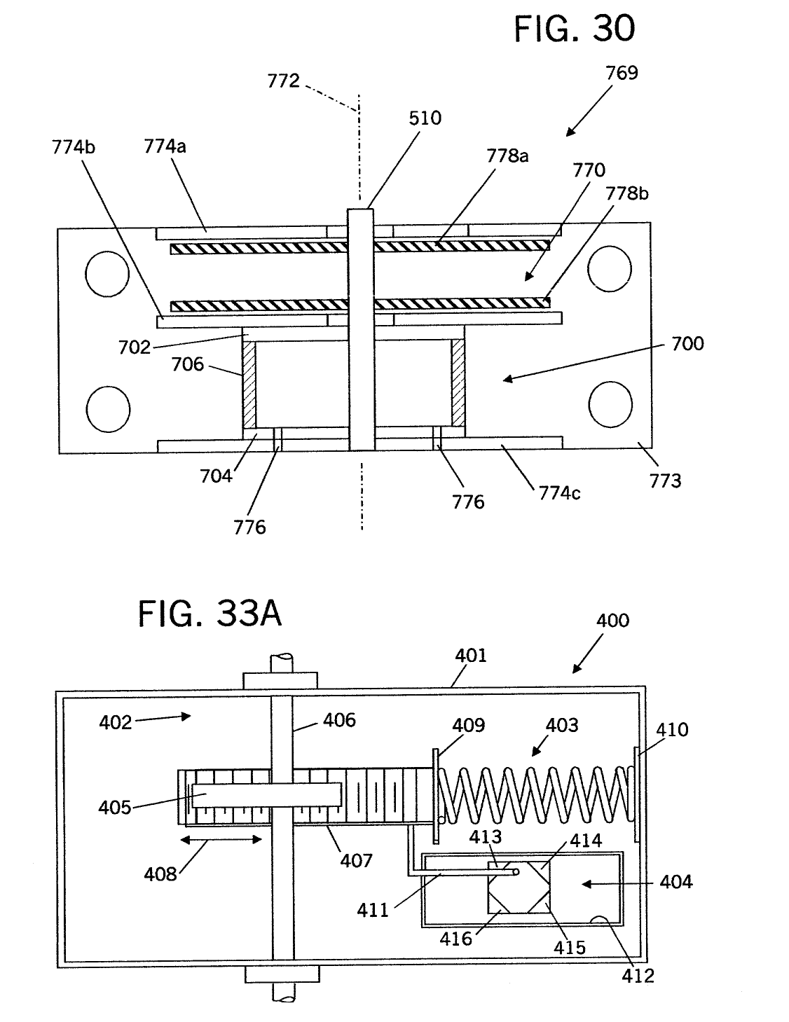

An ninth embodiment door closer 769 is shown in FIG. 30. The door closer includes torsion spring 700 described hereinabove and torsion damper 770. The damper and spring rotate about common axis 772. The housing includes rigid base 773 with ridges or plates 774a, 774b and 774c extending outwardly from the base. The base and ridges are enclosed by a suitable shroud (not shown). The base is conventionally fastened by a bolt or other suitable connection to a frame or door and the rotary motion is inputted to the damper and spring at input shaft 510. No cam or rack and pinion is needed with the combined torsional elements because a conversion of rotary to linear motion is not required. Pins connect spring plate 704 to ridge 774c. The plate 704 may include a series of spaced apart openings that provide the spring to be indexed or rotated to cause the spring to be preloaded. During door displacement, the opposite spring plate 702 is free to rotate with shaft 510 and relative to ridge 774b.

Resilient elements 778a and 778b are fixed to the input shaft to rotate with the shaft. The resilient elements 778b and 778a are located adjacent fixed plates 774b and 774a respectively. As the shaft rotates in a first direction the elements freely rotate with the shaft without engaging the fixed plates 774a and 774b. When the door is closed and the shaft is rotated in the opposite direction, the shaft urges the resilient members into engagement with the contact surfaces 774a and 774b. The means for urging the resilient members may be comprised of a conventional ratcheting central core or a tapered member. If a tapered member is used, hydraulic forces cause the member to retract from the resilient members when the door is opened and the hydraulic forces urge the member into contact with plates 774a and 774b when the door is closed.

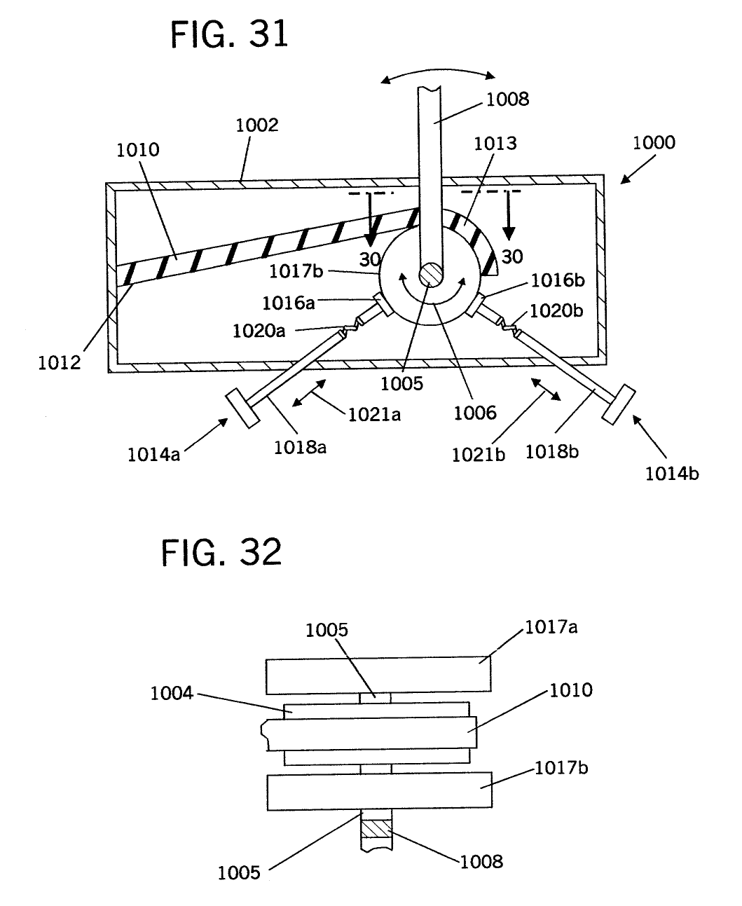

FIGS. 31 and 32 show a tenth embodiment door closer 1000 substantially enclosed by housing 1002. The closer 1000 includes input member 1004 which may be an eccentric cam or circular shaft. The input member is fixed along shaft 1005 and rotates about an axis defined by the shaft in directions identified by arrows 1006 in response to movement of link which may be link 40b of double arm door closer 32 for example. As shown in FIGS. 29 and 30, the input member 1004 is fixed to shaft 1005 at approximately the center of the input member.

An elongate resilient member 1010 has a first end 1012 joined to housing 1002 and a second end 1013 wrapped partially around and fixed to input member 1004. The resilient member serves as the return means of the closer 1000. As shown in FIG. 29 the resilient member is wrapped around the input member approximately ninety degrees. The resilient member is fixed to the housing and input member using any suitable adhesive such as Chemlok® adhesive manufactured by Lord Corporation of Erie, Pennsylvania.

Surface Effect damping is provided by adjustable damping means 1014a and 1014b and movable members 1017a and 1017b. Each adjustable damping means is the same and includes damping elements 1016a and 1016b adapted to be in contact with respective members 1017a and 1017b fixed to shaft 1005 and located on opposite sides of input member 1004. The elements 1016a and 1016b are located proximate the members 1017a and 1017b. Like input member 1004, the members 1017a and 1017b may be fixed to the shaft either eccentrically or at the member centers as shown in FIGS. 29 and 30. The damping means 1014a and 1014b further comprise, adjustment screw 1018a and 1018b for threadably moving the damping elements axially toward and away from the respective members 1017a and 1017b in directions 1021a and 1021b to change the supplied damping. Each adjustment screw and damping element is joined by a spring means 1020a and 1020b which may be any suitable spring member such as a coil spring. Although damping elements 1016a and 1016b are shown in contact with respective members 1017a and 1017b it should be understood that any number of elements 1016 and members 1017 may be used in combination. Additionally, the door closer may not include discrete members 1017 and one or more damping elements 1016 may be in direct contact with the input member 1004.

In use, as the door is opened and link 1008 is moved shaft 1005 and input member 1006 rotate clockwise and cause the resilient member 1010 to wrap around the input member 1004 and stretch. The elements 1016a and 1016b provide damping to the members 1017a and 1017b. When the door is released the resilient member draws the input member 1004 in the counterclockwise direction urging the door closed. During closing the damping elements again damp the rotation of the members 1017a and 1017b.

### Additional Linearly Acting Door Closers

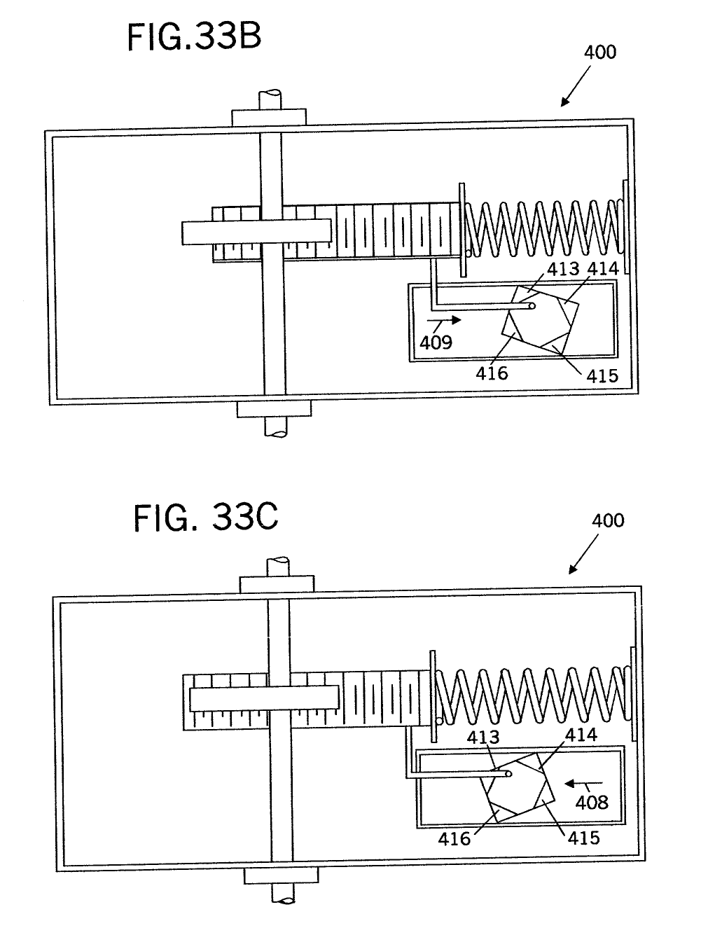

FIGS. 33a, 33b and 33c schematically illustrate a eleventh embodiment door closer 400, and as shown schematically in the figures, housing 401 encloses input member 402, return means 403 and damping means 404. The input member is comprised of pinion 405 fixed to shaft 406 and engageable with linear rack 407 that is movable linearly in direction 408 in the manner previously described in connection with the first embodiment door closer 100. Further description of the operation of the input member is not required. Plates 409 and 410 are respectively fixed to the end of rack 407 and wall of housing 401 and return means is located between the plates. As shown in FIGS. 33a-233c the return means 403 is a steel coil spring with the end coils fixed to the plates in a conventional manner however it should be understood that the return means could be any suitable energy storage means such as a resilient member for example.

A rigid L-shaped link member 411 joins the rack to damping element 404 so that during rack displacement, the damping element also is displaced through damping chamber 412 in a direction that is substantially parallel to the direction of rack 407. The end of link member 411 connected to damping element 404 connects to the element eccentrically above the center of the damping mass. For purposes of describing the preferred embodiment of the invention the damping element is a block that has four opposed contact portions 413, 414, 415 and 416. However it should be understood that the element may comprise any suitable solid or hollow mass with any number of contact portions. Additionally, although the sides of the mass are shown substantially flat, the sides may include ridges to further contribute to the surface effect damping provided. Additionally the sliding surface can be rounded or rectangular. The lateral dimension of the damping chamber is larger than the thickness or lateral dimension of the block. This allows the block to have space to tilt or rotate as it is displaced along axis 420 through the chamber. When the rack is displaced, movement of the link causes the eccentrically connected block to rotate at the link connection point until opposed contact portions are in contact with the wall of damping chamber 412. The contact portions may be the same material as the block or may be any material that will provide the required damping to the input and return members. When the rack and block 404 are moved from their stationary positions as the door is opened the block is rotated clockwise until contact portions 413 and 415 tilt into contact with the chamber wall. See FIG. 33b. The contact portions provide the limited damping desired as the door is opened. As the spring returns the rack and damping element to their initial positions, the damping element is rotated about eccentric connection until contact portions 414 and 416 are in contact with the chamber wall. As the element 404 is displaced through chamber along axis 420 surface effect damping is supplied. See FIG. 33c.

The tiltable damping element as disclosed may be used in the single arm and double arm closers as shown in FIGS. 2 and 3 and alternatively the elements may be aligned for use in a strut type door closer like closer 10.

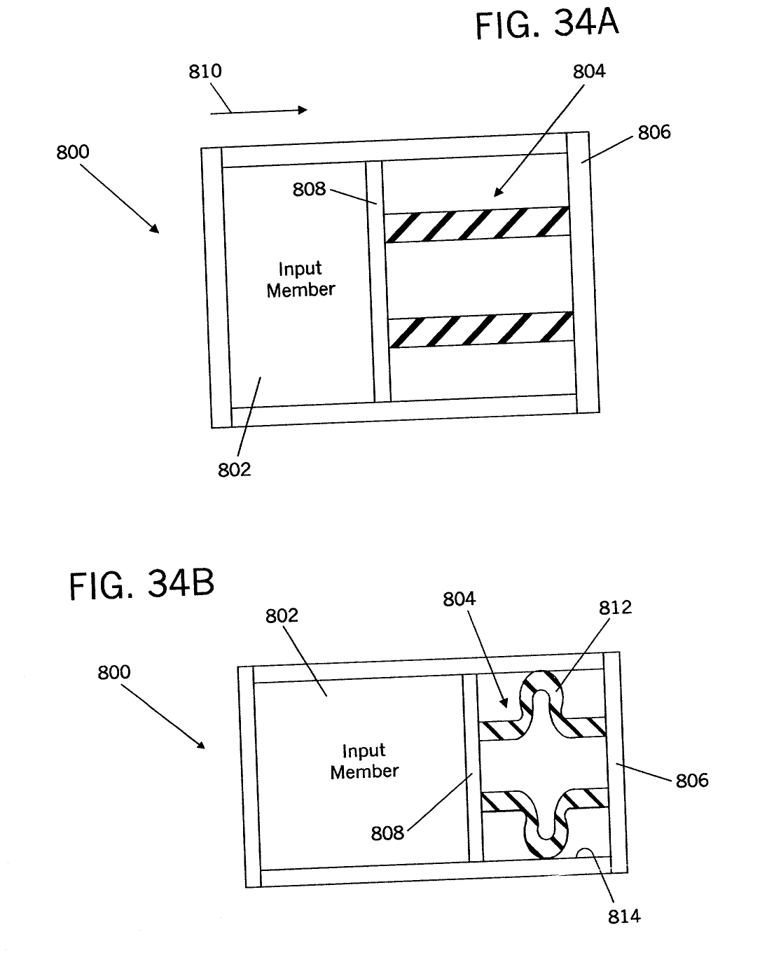

An twelfth embodiment door closer 800 illustrated in FIGS. 34a and 34b is comprised of an input member 802 represented schematically which may include a rack and pinion or cam for example, and a combination spring damper element 804 that is comprised of a hollow cylindrical buckling spring. The combination spring and damper element may assume alternate configurations and the buckling column is disclosed for purposes of describing the eleventh embodiment of the invention. The spring and damper member has one end fixed to the housing end plate 806 and a second end fixed to a movable member 808 to be movable with the member along the longitudinal housing axis by the input member 802. The inner housing wall defines a friction surface 814. The combination spring damper member is made from an elastomeric material and has a stiffness.

As the door is opened, the member is displaced in direction 810 and the member buckles between the fixed member ends. The stiffness of the buckling member provides the spring stiffness and resistance. No friction damping is provided during opening. When the door is opened the buckled portion 812 of the member engages the friction surface. See FIG. 34B. This interaction between the buckled portion of the member and the housing surface provides friction damping when the door is closed and the member is returned to the extended orientation of FIG. 34A.

While we have illustrated and described twelve preferred embodiments of our invention, it is understood that the invention is capable of modification, and we therefore do not wish to be limited to the precise details set forth in the embodiments, but desire to avail ourselves of such changes and alterations as fall within the purview of the following claims.

We claim:

1. A door closer, for controlling the movement of a door, the door closer comprising:
an input member, movable in response to movement of the door, the input member being movable in a first direction and in a second direction;
return means for moving the input member in the second direction; and
damping means for controlling the movement of the input member, the damping means comprising: a rubbing member movable in the first and second directions, and a body for engagement by said rubbing member to produce a surface effect damping force.

2. The door closer as claimed in claim 1 wherein the door closer is rotary acting.

3. The door closer as claimed in claim 1 wherein the door closer is linearly acting.

4. The door closer as claimed in claim 1 wherein the input member is a cam.

5. The door closer as claimed in claim 1 wherein the input member is a rack and pinion.

6. The door closer as claimed in claim 1 wherein the return means is a coil spring.

7. The door closer as claimed in claim 1 wherein the return means is a shear spring.

8. The door closer as claimed in claim 1 wherein the return means is a torsion spring.

9. The door closer as claimed in claim 1 wherein the return means is a buckling spring.

10. The door closer as claimed in claim 1 wherein the return means is a compression spring.

11. The door closer as claimed in claim 1 wherein the rubbing member has an active friction producing area, the damping means including means for varying the damping forces supplied by said damping means by varying the active friction producing area of the rubbing member.

12. The door closer as claimed in claim 1 wherein the damping means provides variable damping forces during operation of the door closer by varying the compression of the rubbing member as a function of the displacement of the rubbing member.

13. The door closer as claimed in claim 1 wherein the rubbing member is adapted to bulge as it is displaced, and wherein the damping means provides variable damping forces during operation of the door closer by varying the amount the rubbing member is bulged as a function of the direction of movement of the rubbing member.

14. The door closer as claimed in claim 1 wherein the rubbing member has a cross sectional area, and wherein the damping means provides variable damping forces by varying the amount the member is compressed as a function of cross-sectional area and direction of movement of the rubbing member.

15. The door closer as claimed in claim 1 wherein the damping means is located between the return means and the input member.

16. The door closer as claimed in claim 1 wherein the damping means controls movement of the input member in the second direction.

17. The door closer as claimed in claim 16 wherein the rubbing member is moved in the second direction when the door is opened.

18. The door closer as claimed in claim 1 wherein the door closer is a strut type door closer.

19. The door closer as claimed in claim 1 wherein the door closer is a single arm type door closer.

20. The door closer as claimed in claim 1 wherein the door closer is a double arm type door closer.

21. A door closer, for controlling the movement of a door, the door closer comprising:
an input member, movable in response to movement of the door, the input member being movable in a first direction and in a second direction; and
a motion control device comprising:
return means for moving the input member in the second direction; and
damping means for controlling the movement of the input member, the damping means comprising: a rubbing member movable in the first and second directions, and a body for engagement by said rubbing member to produce a surface effect damping force.

22. The door closer as claimed in claim 21 wherein the door closer is a rotary acting device.

23. The door closer as claimed in claim 21 wherein the motion control device is comprised of a buckling spring.

24. The door closer as claimed in claim 23 wherein the motion control device includes a housing that substantially surrounds the buckling spring, the buckling spring adapted to engage the housing during movement of the door.

25. The door closer as claimed in claim 1 wherein the damping forces are provided in the first and second directions, the damping forces being greater in the second direction than in the first direction.

26. A door closer for controlling the movement of a door when the door is opened and closed, the door closer comprising:
(A) an input member movable in a first direction and a second direction in response to movement of the door;
s (B) return means for moving the input member in the second direction when the door is closed; and
(C) damping means for controlling the movement of the input member in the second direction, the damping means comprising:
(1) a rubbing element movable in a first direction when the door is opened and in a second direction when the door is closed, the rubbing element being movable in the first direction by the input member; and
(2) a contact member located proximate the rubbing element, the rubbing element being operable in frictional or sliding contact with the contact member to produce a surface effect damping force to the input member as the rubbing element is moved.

27. The door closer as claimed in claim 26 wherein the damping means provides surface effect damping forces when the rubbing element is displaced in the second direction.

28. The door closer as claimed in claim 27 wherein the damping means provides surface effect damping forces when the rubbing element is displaced in the first direction.

29. The door closer as claimed in claim 28 wherein the surface effect damping forces produced between the rubbing element and the contact surface are greater when the rubbing element is displaced in the second direction than when the rubbing element is displaced in the first direction.

30. The door closer as claimed in claim 26 wherein the rubbing element is comprised of a damping pack that includes a plurality of annular members.

31. The door closer as claimed in claim 30 wherein the annular members are fixedly located along the length of a rod.

32. The door closer as claimed in claim 30 wherein the annular members are located along the length of a rod between a wedge and a collar, the annular members adapted to be oriented at an angle relative to a displacement axis when the damping element is moved in a first direction, and oriented substantially perpendicularly to the displacement axis when the damping element is moved in the second direction.

33. The door closer as claimed in claim 32 wherein the wedge includes a support surface adjacent the annular members, the support surface oriented at an angle relative to the axis of displacement.

34. The door closer as claimed in claim 30 wherein the annular members are comprised of nylon.

35. The door closer as claimed in claim 30 wherein the contact surface is comprised of at least one plate having an elastomer along one side of the at least one plate, the annular members adapted to engage the elastomer.

36. The door closer as claimed in claim 35 wherein the contact surface is comprised of two spaced apart plates.

37. The door closer as claimed in claim 36 wherein the damping means comprises means for changing the spacing between the plates.

38. The door closer as claimed in claim 37 wherein the means for changing the plate spacing is comprised of a plurality of fasteners.

39. The door closer as claimed in claim 36 wherein the distance separating the spaced apart plates varies along the path traveled by the damping element.

40. The door closer as claimed in claim 30 wherein the door closer is a linearly acting closer and the input member is located between the return means and the damping means.

41. The door closer as claimed in claim 26 wherein the contact member is comprised of a housing and the rubbing element is comprised of a resilient member movable through the housing along an axis, the housing having a wall and a plurality of annular protuberances provided along the inner surface of the wall, the protuberances adapted to engage the rubbing element as it is displaced through the housing.

42. The door closer as claimed in claim 41 wherein the protuberances are spaced apart along the housing wall to vary the active surface effect damping area between the rubbing element and the contact member.

43. The door closer as claimed in claim 41 wherein the protuberances have a semicircular cross-section.

44. The door closer as claimed in claim 26 wherein the rubbing element is comprised of a wedge located between first and second clamp plates.

45. The door closer as claimed in claim 26 wherein the rubbing element is comprised of a wedge located between first and second clamp plates and the contact member is comprised of a pair of resilient members located adjacent the clamping plates.

46. The door closer as claimed in claim 44 wherein the wedge has a trapezoidal cross section.

47. The door closer as claimed in claim 44 wherein the contact member is comprised of a pair of resilient members located adjacent the clamping plates, and wherein each clamping plate is comprised of a substantially planar outer surface adapted to engage the resilient members, an inner surface and at least one inwardly directed wedge limiting member.

48. The door closer as claimed in claim 47 wherein the inner surface is oriented at an angle that extends inwardly in the second direction.

49. The door closer as claimed in claim 47 wherein each clamp plate includes two inwardly directed wedge limiting members.

50. The door closer as claimed in claim 44 wherein the wedge includes first and second parallel faces joined by first and second contact faces, the first and second contact faces converge as they extend from the first parallel face to the second parallel face.

51. The door closer as claimed in claim 44 wherein the clamping plates are moved apart as the wedge and clamping plates are moved in the second direction.

52. The door closer as claimed in claim 51 wherein the clamping members engage the resilient members as they are moved apart.

53. The door closer as claimed in claim 45 wherein the distance between the resilient members and the outer surfaces of the clamping plates are maintained substantially constant as the rubbing element is moved in a first direction.

54. The door closer as claimed in claim 45 wherein the resilient members have a substantially constant thickness.

55. The door closer as claimed in claim 45 wherein the resilient members have a variable thickness.

56. The door closer as claimed in claim 55 wherein the resilient members include a transition portion from a first thickness to a second thickness to vary the surface effect damping supplied by the damping means as the rubbing element is moved between the rubbing members.

57. The door closer as claimed in claim 44 wherein the input member is located between the damping means and the return means and the input means is coupled to the damping means by a shaft that joins the wedge and the input member.

58. The door closer as claimed in claim 26 wherein the return means is comprised of a double shear element.

59. The door closer as claimed in 26 wherein the door closer includes means for preloading the return means.

60. The door closer as claimed in 59 wherein the return means includes an end, the means for preloading the return means comprising a preload plate threadably connected to an adjustment member.

61. The door closer as claimed in claim 26 wherein the input member, return means and damping means are enclosed by a housing having a wall which defines a chamber.

62. The door closer as claimed in claim 26 wherein the return means is comprised of a double shear element comprising a pair of outer plates fixed to the housing wall, a center plate, and resilient members joining the outer and center plates.

63. The door closer as claimed in claim 62 wherein the return means is connected to the damping means by the center plate.

64. The door closer as claimed in claim 26 wherein the return means is comprised of a rigid frame, first and second load plates and resilient members joining the frame and load plates.

65. The door closer as claimed in claim 64 wherein the rigid frame has an H-shape that includes parallel arms joined by body, the resilient members having a V-shape and extending between the arms.

66. The door closer as claimed in claim 65 wherein each resilient member includes a slot, the load plates being located in the slots.

67. The door closer as claimed in claim 61 wherein the contact member is comprised of a plurality of indentions along a portion of the housing wall.

68. The door closer as claimed in claim 67 wherein the housing includes means for changing the distance separating opposite portions of the housing.

69. The door closer as claimed in claim 68 wherein said means for changing the distance separating opposite portions of the housing is comprised of at least one hinge along the exterior of the housing and fastener means that extends through the housing so that as the fastener means is loosened and tightened the distance separating the opposite portions of the housing wall is varied to thereby vary the surface effect damping forces provided.

70. The door closer as claimed in claim 69 wherein the housing includes two hinges, each comprising a depression formed along the housing wall.

71. The door closer as claimed in claim 26 wherein the rubbing element is comprised of a unitary resilient element.

72. The door closer as claimed in claim 26 wherein the rubbing element is comprised of a resilient element comprised of first and second portions separated by a gap, the first and second portions adapted to bulge into the gap as the rubbing member is moved in the first and second directions.

73. The door closer as claimed in claim 71 wherein the rubbing element includes a slotted plate with the unitary resilient element formed on the slotted plate.

74. The door closer as claimed in claim 72 wherein the rubbing element includes a frame that includes a slotted plate and opposed first and second spool members, the first and second resilient portions being formed on the spool portions.

75. The door closer as claimed in claim 73 wherein the resilient element has a first end with a contact plate made integral with the first resilient member end, the contact plate adapted to engage the input member.

76. The door closer as claimed in claim 73 wherein the damping means is enclosed by a housing having opposite portions separated by a distance, and wherein the damping means includes means for adjusting the distance separating opposite portions of the housing, the adjustment means extending through the slotted plate.

77. The door closer as claimed in claim 74 wherein the damping means is enclosed by a housing having opposite housing portions separated by a distance, and wherein the damping means includes means for adjusting the distance separating opposite portions of the housing, the adjustment means extending through the slotted plate.

78. The door closer as claimed in claim 26 wherein the damping means is comprised of damping means that provides surface effect forces that vary as a function of displacement of the rubbing element.

79. The door closer as claimed in claim 78 wherein the contact member includes inner wall that is tapered inwardly.

80. The door closer as claimed in claim 79 wherein the wall has a surface contour that is substantially linear.

81. The door closer as claimed in claim 78 wherein the contact member includes an inner wall that has a surface contour that is substantially non-linear.

82. The door closer as claimed in claim 81 wherein the contour is comprised of at least one hill and at least one valley.

83. The door closer as claimed in claim 26 wherein the rubbing element is comprised of inner and outer nested tubular members each having an outwardly extending flange at a member end, the rubbing element further comprising an elastomeric member around the outer member and between the flanges.

84. The door closer as claimed in claim 83 wherein the elastomer member is compressed between the flanges as the door is opened and closed.

85. The door closer as claimed in claim 26 wherein the rubbing element is comprised of a member that is eccentrically linked to the input member.

86. The door closer as claimed in claim 85 wherein the rubbing element is comprised of a block having opposed contact portions, the contact portions adapted to engage the contact member, said portion comprised of material required to provide the requisite surface effect damping.

87. The door closer as claimed in claim 85 wherein the rubbing element is linked to the input member by a rigid L-shaped link, and the contact member is comprised of a damping chamber.

88. The door closer as claimed in claim 85 wherein the input member and return means are aligned and the damping means is offset from the input member and return means.

89. The door closer as claimed in claim 86 wherein the rubbing element is a block having two pairs of opposed portions, the material comprising the opposed portions of the rubbing element being the same.

90. The door closer as claimed in claim 26 wherein the input member includes a rotatable input shaft, the damping means being operatively connected to the input shaft to be rotatable with the shaft.

91. The door closer as claimed in claim 26 wherein the rubbing element comprises a cylindrical resilient member and wherein the contact member comprises a unitary damping band that substantially shrouds the rubbing member.

92. The door closer as claimed in claim 91 wherein the damping band comprises substantially straight end portions joined by a semicircular portion, the greatest surface effect damping occurring when the rubbing element contacts the end portions.

93. The door closer as claimed in 91 wherein the input member includes an input shaft, the rubbing member being fixed along the shaft length to be rotatable with the shaft.

94. The door closer as claimed in claim 91 wherein the input member is comprised of a rack and pinion, the damping band being fixed to the pinion.

95. The door closer as claimed in claim 94 wherein the rack and the return means are aligned.

96. The door closer as claimed in claim 26 wherein the rubbing element comprises a resilient friction layer bonded to a shroud, the contact member comprising a shaft operably connected to said input member.

97. The door closer as claimed in claim 96 wherein the shroud and friction layer are arcuate.

98. The door closer as claimed in claim 96 wherein the shroud and friction layer are planar.

99. The door closer as claimed in claim 96 further comprising means for changing the surface effect damping force supplied by the damping means.

100. The door closer as claimed in claim 99 wherein said means for changing the surface effect damping force is comprised of a set screw joined to one end of the shroud.

101. The door closer as claimed in claim 99 wherein said means for changing the surface effect damping force is comprised of at least one set screw contacting the shroud between the shroud ends.

102. The door closer as claimed in claim 101 wherein said means for changing the surface effect damping is comprised of two screws.

103. The door closer as claimed in claim 97 further comprising means for changing the surface effect damping force supplied by the damping means, said means for changing the surface effect damping comprising a pair of screws contacting the shroud between the shroud ends.

104. The door closer as claim 98 further comprising means for changing the surface effect damping force supplied by the damping means, said means for changing the surface effect damping comprising a pair of set screws that contact the shroud between peripheral shroud edges.

105. The door closer as claimed in claim 26 wherein the input member comprises a rotatable shaft, and wherein the rubbing element comprises a resilient element and the contact member comprises a housing connected to the input member to be rotatable with said member wherein the housing comprises a channel of diminishing volume, said rubbing element adapted to move through the channel as the housing is rotated, the surface effect damping forces being greater at one end of the channel than at the opposite channel end.

106. The door closer as claimed in claim 105 wherein the channel is defined by a disk, raised inner wall and an outer wall.

107. The door closer as claimed in claim 106 wherein the channel has a crescent shape with a first open end and a second substantially closed end.

108. The door closer as claimed in claim 26 wherein the input member is comprised of a shaft, the damping means and return means being operably connected to the shaft along the length of the shaft.

109. The door closer as claimed in claim 108 wherein the return means is comprised of a torsion spring and the damping means is comprised of a torsion damper.

110. A door closer for controlling the movement of a door, the door closer comprising:
an input member movable in response to movement of the door, the input member being movable in a first direction and in a second direction;
a housing having a wall; and
input member motion control means return means for controlling the movement of the input member in the second direction by contacting the housing wall to provide surface effect damping forces, and resisting movement of the input member in the first direction.

111. The door closer as claimed in claim 110 wherein the motion control means is a buckling spring.

112. A door closer for controlling the movement of a door as the door is opened and closed, the door closer comprising: an input member movable in response to movement of the door, the input member being movable in a first direction and in a second direction; return means for moving the input member in the second direction; and damping means for controlling the movement of the input member in the second direction, the damping means comprising: a rubbing member movable in the first and second directions, and a body for engagement by said rubbing member to produce a surface effect damping force in at least one of the first or second directions.

113. The door closer as claimed in claim 1 wherein the damping means rubbing member comprises a rubbing member body having an hourglass shape, the damping force provided by the damping means being force dependent.

114. The door closer as claimed in claim 1 wherein the damping means comprises a rubbing member body having first and second ends and contact discs attached to the ends, the contact members having rounded peripheral portions adapted to contact the body.

115. The door closer as claimed in claim 1 the damping means comprising a rubbing member body having first and second ends and cup members attached to the body ends.

116. The door closer as claimed in claim 115, the cup members having a conical shape and rounded peripheral portions, the rounded peripheral portions being in contact with the body.

117. The door closer as claimed in claim 1 the damping means comprising a rubbing member body and a plurality of cup members in contact with the rubbing member body.

118. The door closer as claimed in claim 1 the return means comprising a resilient band.

119. The door closer as claimed in claim 118 wherein the door closer is enclosed by a housing, the resilient band being connected between the housing and the input member.

120. The door closer as claimed in claim 1 wherein the return means is a tension spring.

121. The door closer as claimed in claim 1 wherein the damping forces for controlling the door vary as a function of door force.

122. The door closer as claimed in claim 1 wherein the damping forces for controlling the door vary as a function of the velocity at which the rubbing member is displaced.

123. The door closer as claimed in claim 1 wherein the damping forces for controlling door motion vary as a function of the bulge volume of the rubbing member.

124. The door closer as claimed in claim 1 wherein the damping forces for controlling door motion vary as a function of the engagement area between the rubbing member and the body.

125. The door closer as claimed in claim 1 wherein the door is opened as it is moved in the first direction and is closed as it is moved in the second direction.

126. The door closer as claimed in claim 1 wherein the door is closed as it is moved in the first direction and is opened as it is moved in the second direction.

127. The door closer as claimed in claim 1 wherein the input member is a mechanical linkage.

128. The door closer as claimed in claim 1 wherein the input member is a cable.

129. The door closer as claimed in claim 1 wherein the input member is a rotating shaft.

130. The door closer as claimed in claim 1 wherein the return means is made from a one of the materials of the group comprising polymeric, metallic, ceramic or composite materials.

131. The door closer as claimed in claim 1 wherein one or both of the body and rubbing member is impregnated with a lubricant.
